(19) United States
(12) Patent Application Publication
(10) Pub. No.: US 2021/0042819 A1
(43) Pub. Date: Feb. 11, 2021

(54) METHOD AND APPARATUS FOR TRADING VIRTUAL PET COMMODITY

(71) Applicant: Tencent Technology (Shenzhen) Company Limited, Shenzhen (CN)

(72) Inventors: Yicheng ZHANG, Shenzhen (CN); Wei PENG, Shenzhen (CN); Xingcai JIANG, Shenzhen (CN); Zhihua ZENG, Shenzhen (CN)

(73) Assignee: Tencent Technology (Shenzhen) Company Limited, Shenzhen (CN)

(21) Appl. No.: 17/078,927

(22) Filed: Oct. 23, 2020

Related U.S. Application Data
(63) Continuation of application No. PCT/CN2019/102170, filed on Aug. 23, 2019.

(30) Foreign Application Priority Data
Aug. 30, 2018 (CN) 201811006230.3

(51) Int. Cl. G06Q 30/06; G06Q 20/12; G06Q 20/40; A63F 13/792; A63F 13/825

(52) U.S. Cl. CPC G06Q 30/0643; G06Q 20/123; G06Q 20/401; G06Q 2220/00; A63F 13/825; A63F 2300/575; A63F 13/792

(57) ABSTRACT

A method for trading a virtual pet commodity is provided, performed by a server providing backend support for an application program, the application program being provided with virtual pets, and at least one pet image of each of the virtual pet being generated based on a genetic inheritance rule. The method includes: receiving a purchase request transmitted by a first terminal; obtaining first verification information according to the purchase request, the first verification information being information stored in a blockchain system; and transferring ownership of the first pet commodity from a second account to a first account when the first verification information indicates that the purchase request is valid.

### RELATED APPLICATION

This application is a continuation application of the International PCT Application No. PCT/CN2019/102170, filed with the China National Intellectual Property Administration, PRC on Aug. 23, 2019 which claims priority to Chinese Patent Application No. 201811006230.3, entitled “METHOD AND APPARATUS FOR TRADING VIRTUAL PET COMMODITY, DEVICE, AND STORAGE MEDIUM” and filed with the China National Intellectual Property Administration, PRC on Aug. 30, 2018, which are incorporated herein by reference in their entireties.

### FIELD OF THE TECHNOLOGY

This disclosure relates to the field of computer application technologies, and in particular, to a method, an apparatus, a device, and a storage medium for trading a virtual pet commodity.

### BACKGROUND OF THE DISCLOSURE

An application program providing a virtual pet usually has a virtual pet trading function, to help a user purchase a virtual pet from a system or another user.

In the related technology, the application program may provide a trading interface used for pet trading, and the user requests to purchase a virtual pet from a server or releases and sells a virtual pet through the trading interface. After receiving the request, the server verifies validity of the trading related request according to related verification information stored locally, for example, verifies whether the user has sufficient resources to purchase or sell a virtual pet. After the verification succeeds, the server updates ownership of the virtual pet.

However, in the related technology, the related verification information used for verifying the validity of the trading request is stored in the same server of the application program. Consequently, there are some security risks, causing relatively low security for trading a virtual pet.

### SUMMARY

A method for trading a virtual pet commodity is provided, performed by a server or a server cluster providing backend support for an application program, the application program being provided with a virtual pet, and at least one pet image of the virtual pet being generated based on a genetic inheritance rule, the method including:

receiving a purchase request transmitted by a first terminal, the purchase request being used for requesting to purchase a first pet commodity, and the first pet commodity being a first virtual pet or a virtual prop used for obtaining the first virtual pet;

obtaining first verification information according to the purchase request, the first verification information being first type information that is stored in a blockchain system and that is used for indicating validity of the purchase request; and

transferring ownership of the first pet commodity from a second account to a first account when the first verification information indicates that the purchase request is valid, the first account being an account logging in to the first terminal and initiating the purchase request, and the second account being an account selling the first pet commodity.

A method for trading a virtual pet commodity is provided, performed by a terminal on which an application program is run, the application program being provided with a virtual pet, and at least one pet image of the virtual pet being generated based on a genetic inheritance rule, the method including:

displaying a trading interface of the application program, the trading interface including a purchase control of a first pet commodity, and the first pet commodity being a first virtual pet or a virtual prop used for obtaining the first virtual pet;

transmitting a purchase request to a server or a server cluster when a triggering operation on the purchase control is detected, the purchase request being used for triggering the server cluster to obtain first verification information; and transferring ownership of the first pet commodity from a second account to a first account when the first verification information indicates that the purchase request is valid, the first verification information being first type information that is stored in a blockchain system and that is used for indicating validity of the purchase request, the first account being an account logging in to the terminal and initiating the purchase request, and the second account being an account selling the first pet commodity; and

displaying the first pet commodity in a pet display interface of the application program, the pet display interface being used for displaying a virtual pet owned by the first account.

A method for trading a virtual pet commodity is provided, performed by a terminal on which an application program is run, the application program being provided with a virtual pet, and at least one pet image of the virtual pet being generated based on a genetic inheritance rule, the method including:

displaying a pet display interface of the application program, the pet display interface being used for displaying a pet commodity owned by a second account logging in to the terminal;

displaying, when a triggering operation on a first pet commodity in the pet display interface is detected, a pet information interface of the first pet commodity, the pet information interface of the first pet commodity including a sale control of the first pet commodity, and the first pet commodity being a first virtual pet or a virtual prop used for obtaining the first virtual pet; and

transmitting a release request to a server cluster when a triggering operation on the sale control is detected, the release request being used for triggering the server cluster to obtain third verification information; and releasing (or listing) the first pet commodity in a trading interface of the application program when the third verification information indicates that the release request is valid, the third verification information being release verification information that is stored in a blockchain system and that is used for indicating validity of the release request.

A method for trading a virtual pet commodity is provided, performed by a terminal on which an application program is run, the application program being provided with a virtual pet, and at least one pet image of the virtual pet being generated based on a genetic inheritance rule, the method including:

displaying a pet display interface of the application program, the pet display interface being used for displaying a pet commodity owned by a third account, and the third account being an account logging in to the terminal;

displaying, when a triggering operation on a second pet commodity in the pet display interface is detected, a pet information interface of the second pet commodity, the second pet commodity being a virtual pet having been released in the trading interface, the pet information interface including a suspension control of the second pet commodity, and the second pet commodity being a second virtual pet or a virtual prop used for obtaining the second virtual pet; and

transmitting a suspension request to a server cluster when a triggering operation on the suspension control is detected, the suspension request being used for triggering the server cluster to obtain fifth verification information; and suspending (or delisting) the second pet commodity from the trading interface when the fifth verification information indicates that the suspension request is valid, the fifth verification information being suspension verification information that is stored in a blockchain system and that is used for indicating validity of the suspension request.

An apparatus for trading a virtual pet commodity is provided, applied to a server or a server cluster providing backend support for an application program, the application program being provided with a virtual pet, and at least one pet image of the virtual pet being generated based on a genetic inheritance rule, the apparatus including:

a purchase request receiving module, configured to receive a purchase request transmitted by a first terminal, the purchase request being used for requesting to purchase a first pet commodity, and the first pet commodity being a first virtual pet or a virtual prop used for obtaining the first virtual pet;

a first verification information obtaining module, configured to obtain first verification information according to the purchase request, the first verification information being first type information that is stored in a blockchain system and is used for indicating validity of the purchase request; and

a trading module, configured to transfer ownership of the first pet commodity from a second account to a first account when the first verification information indicates that the purchase request is valid, the first account being an account logging in to the first terminal and initiating the purchase request, and the second account being an account selling the first pet commodity.

An apparatus for trading a virtual pet commodity is provided, applied to a terminal on which an application program is run, the application program being provided with a virtual pet, and at least one pet image of the virtual pet being generated based on a genetic inheritance rule, the apparatus including:

a trading interface display module, configured to display a trading interface of the application program, the trading interface including a purchase control of a first pet commodity, and the first pet commodity being a first virtual pet or a virtual prop used for obtaining the first virtual pet;

a purchase request transmission module, configured to transmit a purchase request to a server cluster when a triggering operation on the purchase control is detected, the purchase request being used for triggering the server cluster to obtain first verification information; and transfer ownership of the first pet commodity from a second account to a first account when the first verification information indicates that the purchase request is valid, the first verification information being first type information that is stored in a blockchain system and that is used for indicating validity of the purchase request, the first account being an account logging in to the terminal, and the second account being an account selling the first pet commodity; and

a commodity display module, configured to display the first pet commodity in a pet display interface of the application program, the pet display interface being used for displaying a virtual pet owned by the first account.

An apparatus for trading a virtual pet commodity is provided, applied to a terminal on which an application program is run, the application program being provided with a virtual pet, and at least one pet image of the virtual pet being generated based on a genetic inheritance rule, the apparatus including:

a pet interface display module, configured to display a pet display interface of the application program, the pet display interface being used for displaying a pet commodity owned by a second account, and the second account being an account logging in to the terminal;

an information interface display module, configured to display, when a triggering operation on a first pet commodity in the pet display interface is detected, a pet information interface of the first pet commodity, the pet information interface of the first pet commodity including a sale control of the first pet commodity, and the first pet commodity being a first virtual pet or a virtual prop used for obtaining the first virtual pet; and

a release request transmission module, configured to transmit a release request to a server or a server cluster when a triggering operation on the sale control is detected, the release request being used for triggering the server cluster to obtain third verification information; and release the first pet commodity in a trading interface of the application program when the third verification information indicates that the release request is valid, the third verification information being release verification information that is stored in a blockchain system and that is used for indicating validity of the release request.

An apparatus for trading a virtual pet commodity is provided, applied to a terminal on which an application program is run, the application program being provided with a virtual pet, and at least one pet image of the virtual pet being generated based on a genetic inheritance rule, the apparatus including:

a pet interface display module, configured to display a pet display interface of the application program, the pet display interface being used for displaying a pet commodity owned by a third account, and the third account being an account logging in to the terminal;

an information interface display module, configured to display, when a triggering operation on a second pet commodity in the pet display interface is detected, a pet information interface of the second pet commodity, the second pet commodity being a virtual pet having been released in the trading interface, the pet information interface including a suspension control of the second pet commodity, and the second pet commodity being a second virtual pet or a virtual prop used for obtaining the second virtual pet; and

a suspension request transmission module, configured to transmit a suspension request to a server cluster when a triggering operation on the suspension control is detected, the suspension request being used for triggering the server cluster to obtain fifth verification information; and suspend (or unlist) the second pet commodity from the trading interface when the fifth verification information indicates that the suspension request is valid, the fifth verification information being suspension verification information that is stored in a blockchain system and that is used for indicating validity of the suspension request.

A server cluster is provided, including a processor and a memory, the memory storing at least one computer-readable instruction, and the computer-readable instruction being loaded and executed by the processor to implement the following operations:

receiving a purchase request transmitted by a first terminal, the purchase request being used for requesting to purchase a first pet commodity, and the first pet commodity being a first virtual pet or a virtual prop used for obtaining the first virtual pet;

obtaining first verification information according to the purchase request, the first verification information being first type information that is stored in a blockchain system and that is used for indicating validity of the purchase request; and

transferring ownership of the first pet commodity from a second account to a first account when the first verification information indicates that the purchase request is valid, the first account being an account logging in to the first terminal and initiating the purchase request, and the second account being an account selling the first pet commodity.

A terminal is provided, including a processor and a memory, the memory storing at least one computer-readable instruction, and the computer-readable instruction being loaded and executed by the processor to implement the following operations:

displaying a trading interface of the application program, the trading interface including a purchase control of a first pet commodity, and the first pet commodity being a first virtual pet or a virtual prop used for obtaining the first virtual pet;

transmitting a purchase request to a server cluster when a triggering operation on the purchase control is detected, the purchase request being used for triggering the server cluster to obtain first verification information; and transferring ownership of the first pet commodity from a second account to a first account when the first verification information indicates that the purchase request is valid, the first verification information being first type information that is stored in a blockchain system and that is used for indicating validity of the purchase request, the first account being an account logging in to the terminal, and the second account being an account selling the first pet commodity; and

displaying the first pet commodity in a pet display interface of the application program, the pet display interface being used for displaying a virtual pet owned by the first account.

A terminal is provided, including a processor and a memory, the memory storing at least one computer-readable instruction, and the computer-readable instruction being loaded and executed by the processor to implement the following operations:

displaying a pet display interface of the application program, the pet display interface being used for displaying a pet commodity owned by a second account, and the second account being an account logging in to the terminal;

displaying, when a triggering operation on a first pet commodity in the pet display interface is detected, a pet information interface of the first pet commodity, the pet information interface of the first pet commodity including a sale control of the first pet commodity, and the first pet commodity being a first virtual pet or a virtual prop used for obtaining the first virtual pet; and

transmitting a release request to a server cluster when a triggering operation on the sale control is detected, the release request being used for triggering the server cluster to obtain third verification information; and releasing (or listing) the first pet commodity in a trading interface of the application program when the third verification information indicates that the release request is valid, the third verification information being release verification information that is stored in a blockchain system and that is used for indicating validity of the release request.

A terminal is provided, including a processor and a memory, the memory storing at least one computer-readable instruction, and the computer-readable instruction being loaded and executed by the processor to implement the following operations:

displaying a pet display interface of the application program, the pet display interface being used for displaying a pet commodity owned by a third account, and the third account being an account logging in to the terminal;

displaying, when a triggering operation on a second pet commodity in the pet display interface is detected, a pet information interface of the second pet commodity, the second pet commodity being a virtual pet having been released (or listed) in the trading interface, the pet information interface including a suspension control of the second pet commodity, and the second pet commodity being a second virtual pet or a virtual prop used for obtaining the second virtual pet; and

transmitting a suspension request to a server cluster when a triggering operation on the suspension control is detected, the suspension request being used for triggering the server cluster to obtain fifth verification information; and suspending (or delisting) the second pet commodity from the trading interface when the fifth verification information indicates that the suspension request is valid, the fifth verification information being suspension verification information that is stored in a blockchain system and that is used for indicating validity of the suspension request.

A non-volatile computer-readable storage medium is provided, storing at least one computer-readable instruction, the computer-readable instruction being loaded and executed by a processor to implement the following operations:

receiving a purchase request transmitted by a first terminal, the purchase request being used for requesting to purchase a first pet commodity, and the first pet commodity being a first virtual pet or a virtual prop used for obtaining the first virtual pet;

obtaining first verification information according to the purchase request, the first verification information being first type information that is stored in a blockchain system and that is used for indicating validity of the purchase request; and

transferring ownership of the first pet commodity from a second account to a first account when the first verification information indicates that the purchase request is valid, the first account being an account logging in to the first terminal and initiating the purchase request, and the second account being an account selling the first pet commodity.

A non-volatile computer-readable storage medium is provided, storing at least one computer-readable instruction, the computer-readable instruction being loaded and executed by a processor to implement the following operations:

displaying a trading interface of the application program, the trading interface including a purchase control of a first pet commodity, and the first pet commodity being a first virtual pet or a virtual prop used for obtaining the first virtual pet;

transmitting a purchase request to a server cluster when a triggering operation on the purchase control is detected, the purchase request being used for triggering the server cluster to obtain first verification information; and transferring ownership of the first pet commodity from a second account to a first account when the first verification information indicates that the purchase request is valid, the first verification information being first type information that is stored in a blockchain system and that is used for indicating validity of the purchase request, the first account being an account logging in to the terminal and initiating the purchase request, and the second account being an account selling the first pet commodity; and

displaying the first pet commodity in a pet display interface of the application program, the pet display interface being used for displaying a virtual pet owned by the first account.

A non-volatile computer-readable storage medium is provided, storing at least one computer-readable instruction, the computer-readable instruction being loaded and executed by a processor to implement the following operations:

displaying a pet display interface of the application program, the pet display interface being used for displaying a pet commodity owned by a second account, and the second account being an account logging in to the terminal;

displaying, when a triggering operation on a first pet commodity in the pet display interface is detected, a pet information interface of the first pet commodity, the pet information interface of the first pet commodity including a sale control of the first pet commodity, and the first pet commodity being a first virtual pet or a virtual prop used for obtaining the first virtual pet; and

transmitting a release request to a server cluster when a triggering operation on the sale control is detected, the release request being used for triggering the server cluster to obtain third verification information; and releasing the first pet commodity in a trading interface of the application program when the third verification information indicates that the release request is valid, the third verification information being release verification information that is stored in a blockchain system and that is used for indicating validity of the release request.

A non-volatile computer-readable storage medium is provided, storing at least one computer-readable instruction, the computer-readable instruction being loaded and executed by a processor to implement the following operations:

displaying a pet display interface of the application program, the pet display interface being used for displaying a pet commodity owned by a third account, and the third account being an account logging in to the terminal;

displaying, when a triggering operation on a second pet commodity in the pet display interface is detected, a pet information interface of the second pet commodity, the second pet commodity being a virtual pet having been released in the trading interface, the pet information interface including a suspension control of the second pet commodity, and the second pet commodity being a second virtual pet or a virtual prop used for obtaining the second virtual pet; and

transmitting a suspension request to a server cluster when a triggering operation on the suspension control is detected, the suspension request being used for triggering the server cluster to obtain fifth verification information; and suspending the second pet commodity from the trading interface when the fifth verification information indicates that the suspension request is valid, the fifth verification information being suspension verification information that is stored in a blockchain system and that is used for indicating validity of the suspension request.

It is to be understood that the above general descriptions and the following detailed descriptions are merely for exemplary and explanatory purposes, and cannot limit this disclosure.

In this disclosure, the term releasing a virtual pet commodity also refers to listing the virtual pet commodity for sale. The term suspending a virtual pet commodity also refers to delisting the virtual pet commodity.

### BRIEF DESCRIPTION OF THE DRAWINGS

The accompanying drawings, which are incorporated herein and constitute a part of this specification, illustrate embodiments consistent with this disclosure and, together with the specification, serve to explain the principles of this disclosure.

FIG. 1 is a schematic structural diagram of a computer system according to an exemplary embodiment of this disclosure.

FIG. 2 is a schematic flowchart of a method for trading a virtual pet commodity according to an exemplary embodiment of this disclosure.

FIG. 3 is a flowchart of trading a virtual pet involved in the embodiment shown in FIG. 2.

FIG. 4 is a method flowchart of a method for trading a virtual pet commodity according to an exemplary embodiment of this disclosure.

FIG. 5 is a schematic diagram of a trading interface of a virtual cat involved in the embodiment shown in FIG. 4.

FIG. 6 is a schematic diagram of a purchase interface of a virtual cat involved in the embodiment shown in FIG. 4.

FIG. 7 is a schematic diagram of a purchase interface of a cat bell involved in the embodiment shown in FIG. 4.

FIG. 8 is a schematic diagram of a purchase interface of a cat luring bell involved in the embodiment shown in FIG. 4.

FIG. 9 is a schematic diagram of a price trend involved in the embodiment shown in FIG. 4.

FIG. 10 is a schematic diagram of a purchase confirming interface of a virtual cat involved in the embodiment shown in FIG. 4.

FIG. 11 is a schematic diagram of a trading prompt interface involved in the embodiment shown in FIG. 4.

FIG. 12 is a schematic diagram of a purchase confirming interface of a cat luring bell involved in the embodiment shown in FIG. 4.

FIG. 13 is a schematic diagram of a trading success prompt interface involved in the embodiment shown in FIG. 4.

FIG. 14 is a schematic flowchart of purchasing a virtual cat involved in the embodiment shown in FIG. 4.

FIG. 15 is a schematic flowchart of purchasing a cat bell involved in the embodiment shown in FIG. 4.

FIG. 16 is a method flowchart of a method for trading a virtual pet commodity according to an exemplary embodiment of this disclosure.

FIG. 17 is a schematic diagram of a pet information interface of a virtual cat involved in the embodiment shown in FIG. 16.

FIG. 18 is a schematic diagram of a release confirming interface involved in the embodiment shown in FIG. 16.

FIG. 19 is a schematic diagram of displaying a publicity area involved in the embodiment shown in FIG. 16.

FIG. 20 is a schematic diagram of a release display logic involved in the embodiment shown in FIG. 16.

FIG. 21 is a schematic flowchart of releasing a virtual cat involved in the embodiment shown in FIG. 16.

FIG. 22 is a method flowchart of a method for trading a virtual pet commodity according to an exemplary embodiment of this disclosure.

FIG. 23 is a schematic flowchart of suspending a virtual cat involved in the embodiment shown in FIG. 22.

FIG. 24 shows an apparatus for trading a virtual pet commodity according to an exemplary embodiment of this disclosure.

FIG. 25 shows an apparatus for trading a virtual pet commodity according to an exemplary embodiment of this disclosure.

FIG. 26 shows an apparatus for trading a virtual pet commodity according to an exemplary embodiment of this disclosure.

FIG. 27 shows an apparatus for trading a virtual pet commodity according to an exemplary embodiment of this disclosure.

FIG. 28 is a structural block diagram of a computer device according to an exemplary embodiment of this disclosure.

FIG. 29 is a structural block diagram of a computer device according to an exemplary embodiment of this disclosure.

### DESCRIPTION OF EMBODIMENTS

Exemplary embodiments are described in detail herein, and examples of the exemplary embodiments are shown in the accompanying drawings. When the following descriptions relate to the accompanying drawings, unless indicated otherwise, same numbers in different accompanying drawings represent same or similar elements. The implementations described in the following exemplary embodiments do not represent all implementations consistent with this disclosure. On the contrary, the implementations are merely examples of apparatuses and methods that are described in detail in the appended claims and that are consistent with some aspects of this disclosure.

In solutions provided in this disclosure, when a virtual pet is traded, a trading request may be verified through verification information stored in a blockchain system, to improve security of trading the virtual pet. For ease of understanding, several terms involved in this disclosure are explained below first.

Virtual pet: a digital pet presented as a pet image in a cartoon form and/or an animal form. The virtual pet includes a two-dimensional digital pet or a three-dimensional digital pet. For example, a virtual pet may be a three-dimensional virtual pet presented as a pet image in the form of a cartoon cat. Optionally, there are some virtual pets whose pet images are generated randomly. For example, pet images of the 0th-generation virtual pets are generated randomly. There are some virtual pets whose pet images are generated according to a genetic inheritance rule based on pet images of parental virtual pets and/or other ancestral virtual pets. For example, a pet image of a descendant virtual pet other than the 0th-generation virtual pet is generated according to the genetic inheritance rule. Optionally, each virtual pet may have a unique gene sequence, and the gene sequence includes generation parameters for determining a pet image of the virtual pet. The gene sequence is also referred to as image parameters.

In some embodiments, pet information of each virtual pet is stored on a blockchain]] system, and is stored and authenticated through a consensus mechanism for a plurality of nodes on the blockchain system. The pet information at least includes a unique gene sequence of the virtual pet, and further optionally includes at least one of: identification information of the virtual pet, parent information of the virtual pet, generation information of the virtual pet, genealogy information of the virtual pet, historical transaction journal information of the virtual pet, historical career event information of the virtual pet or other information about the virtual pet. Because a gene sequence of each virtual pet is unique and information stored on a blockchain system is true and unique, a virtual pet has a collection attribute. Meanwhile, because pet information of a virtual pet is stored on a blockchain system, even if a virtual pet is a digital pet designed to be used in one application program, the virtual pet may be conveniently migrated to another application programed.

In some embodiments, a virtual pet is a digital pet displayed by an application program running on a terminal. The application program includes at least one of the following functions: capturing a virtual pet, generating a virtual pet, breeding a virtual pet, trading a virtual pet, fighting by using a virtual pet, carrying out augmented reality (AR) interaction by using a virtual pet, carrying out social communication by using a virtual pet, and carrying out AR education by using a virtual pet. In some other embodiments, the application program is an application program for obtaining, breeding and/or trading a virtual pet based on a blockchain system. In some other embodiments, the application program is a geolocation-based social network game program and the social network game program provides at least one function of performing collection, growing, and/or fighting by using a virtual pet.

In some embodiments, the application program has a function of fighting by using a virtual pet. In this case, a gene sequence determines features of a virtual pet. The above-mentioned features may include: extrinsic features and/or intrinsic features.

Extrinsic features refer to features embodying a pet image of a virtual pet. Optionally, a virtual pet may include different body parts such as skin, speckles, ears, beards, patterns, eyes, and a mouth, and each of the body parts may have a variety of different extrinsic features. The extrinsic features may include visible features such as color, shape, texture and the like. For example, extrinsic features of skin may include different colors of white skin, red skin, orange skin, yellow skin, green skin, cyan skin, blue skin, purple skin and the like. In another example, extrinsic features of ears may include different shapes of long ears, short ears, rolled ears, folded ears, normal ears and the like.

Intrinsic features refer to features embodying intrinsic properties of a virtual pet. For example, intrinsic properties may include a variety of different properties such as an intelligence value, an attack power value, a defense power value, a dexterity value, a magic value, a strength value, an endurance value, an agility value, a potential value, a speed value, a health point and the like.

A genetic inheritance rule: also referred to as an inheritance rule, genetic algorithm, or genetic inheritance algorithm, is a rule of handing down pet images of parental virtual pets and/or other ancestral virtual pets by imitating a genetic law of real creatures to generate a pet image of a filial virtual pet. Taking the virtual pet being a 3D virtual pet as an example, the pet image of each virtual pet includes a plurality of types of 3D image materials. The types of 3D image materials correspond to different role parts and/or texture levels. Each 3D image material corresponds to a material identifier. The 3D material identifier can be considered as a “gene”. In some embodiments, to ensure that each virtual pet is a unique customized virtual pet, the unique characteristic is determined by a gene sequence of the virtual pet. In some embodiments, the genetic inheritance rule is a rule of recombining and de-duplicating pet images of parental virtual pets and/or other ancestral virtual pets according to the genetic law to generate a pet image with a unique feature of a filial virtual pet. Deduplication refers to a mechanism of regenerating, when a same gene sequence as that of an existing virtual pet appears in a genetic process, a gene sequence of the virtual pet thereby ensuring genetic uniqueness of the virtual pet. Optionally, because the genetic inheritance rule imitates the inheritance rule of real creatures, there are further restrictions such as duration of pregnancy and forbidden breeding of close relatives.

In this embodiment of this disclosure, there are genetic genes between two virtual pets with a genetic relationship. Genetic genes refer to genes handed down from one of two virtual pets with a genetic relationship to the other. Features determined by genetic genes can be referred to as genetic features. Two virtual pets with a genetic relationship have same genetic features, that is, have same image material features. For example, two virtual pets with a genetic relationship both have yellow skin. In another example, two virtual pets with a genetic relationship both have red skin and folded ears. There may be one or more genetic features, which is not limited in this embodiment of this disclosure. Usually, the closer the generations between two virtual pets with a genetic relationship are, the more genetic features there are; conversely, the farther the generations between two virtual pets with a genetic relationship are, the fewer genetic features there are.

Blockchain: (or block chain) is an intelligent peer-to-peer network that identifies, propagates and records information based on distributed databases, and is also referred to as the Internet of Value.

Trading: trading mentioned in the solutions refers to a blockchain digital virtual pet trading behavior based on a blockchain technology in an application program.

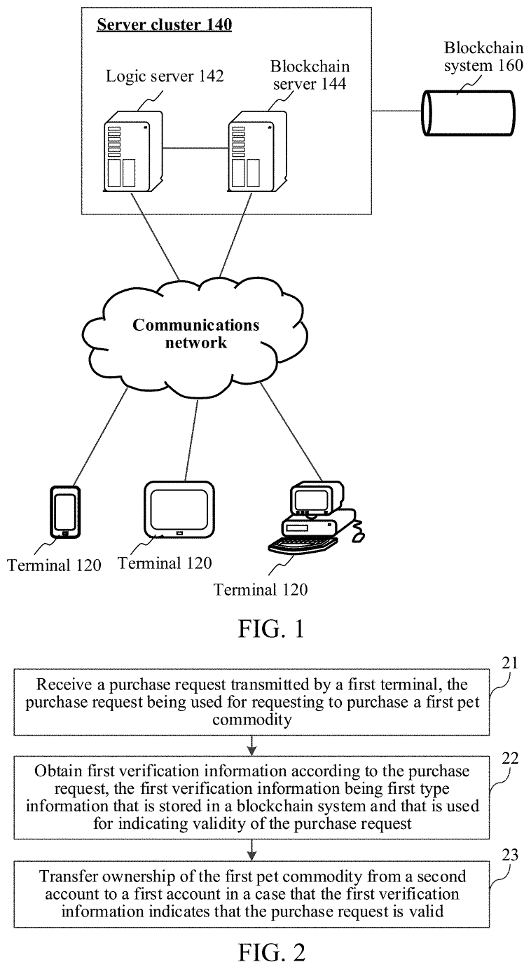

FIG. 1 is a schematic structural diagram of a computer system according to an exemplary embodiment of this disclosure. The system includes: several terminals 120 and a server cluster 140.

The terminal 120 may be a mobile terminal such as a mobile phone, a game console, a tablet computer, an e-book reader, smart glasses, or a Moving Picture Experts Group Audio Layer IV (MP4) player, or the terminal 120 may be a personal computer (PC) such as a laptop portable computer or a desktop computer.

An application program used for providing a virtual pet may be installed in the terminal 120.

The terminal 120 is connected to the server cluster 140 through a communication network. Optionally, the communication network is a wired network or a wireless network.

The server cluster 140 includes at least of a server, a virtualization platform, or a cloud computing service center. The server cluster 140 is configured to provide a backend service for the application program providing a virtual pet. Optionally, the server cluster 140 is responsible for primary computing work, and the terminal 120 is responsible for secondary computing work; or the server cluster 140 is responsible for secondary computing work, and the terminal 120 is responsible for primary computing work; or the terminal 120 and the server cluster 140 perform collaborative computing by using a distributed computing architecture between each other.

In some optional embodiments, the server cluster 140 is configured to store role information and trading record of each virtual pet. The role information includes: a role identifier used for uniquely identifying the virtual pet, an image parameter used for representing a role image of the virtual pet, and data used for representing a status of the virtual pet.

In this application, the server cluster 140 is further connected to a blockchain system 160, and the server cluster 140 stores the role information and/or trading record of each virtual pet in the blockchain system. In some optional embodiments, the server cluster 140 itself may alternatively be used as one node in the blockchain system to run and store data.

Optionally, in this embodiment of this disclosure, the server cluster 140 includes a logic server 142 and a blockchain server 144. The logic server 142 is configured to implement logic control of the application program, for example, perform request processing of trading a virtual pet, account resource management, and interface content management, and the blockchain server 144 as a part of the blockchain system 160 is configured to implement storage of role information and/or trading record of each virtual pet, and decision management of important functions, for example, make a decision on a trading request.

The logic server 142 and the blockchain server 144 may belong to the same computer device, or the logic server 142 and the blockchain server 144 may belong to different computer devices respectively.

Optionally, clients (or clients software) of the application program installed in different terminals 120 are the same, or clients of the application program installed in two terminals 120 are clients of the same type of application program on different control system platforms. Based on different terminal platforms, clients of the application program may also have different specific morphologies. For example, a client of the application program includes a mobile phone client, a PC client, a World Wide Web (Web) client or the like.

A person skilled in the art may learn that, there may be more or fewer terminals 120. For example, there may be only one terminal, or there are dozens of, hundreds of, or more terminals. The quantity or device type of the terminals is not limited in this embodiment of this disclosure.

Optionally, the system may further include a management device (not shown in FIG. 1). The management device is connected to the server cluster 140 through a communication network. Optionally, the communication network is a wired network or a wireless network.

Optionally, the wireless network or the wired network uses a standard communication technology and/or protocol. The network is usually the Internet, but may be any other network, including but not limited to any combination of a local area network (LAN), a metropolitan area network (MAN), a wide area network (WAN), a mobile, wired, or wireless network, a dedicated network or a virtual dedicated network. In some embodiments, technologies and/or formats such as Hypertext Markup Language (HTML) and Extensible Markup Language (XML) are used to represent data exchanged through a network. In addition, all or some links may be encrypted by using conventional encryption technologies such as a Secure Socket Layer (SSL), a Transport Layer Security (TLS), a Virtual Private Network (VPN), and Internet Protocol Security (IPsec). In some other embodiments, customized and/or dedicated data communication technologies may also be used to replace or supplement the foregoing data communication technologies.

FIG. 2 is a schematic flowchart of a method for trading a virtual pet commodity according to an exemplary embodiment of this disclosure. The method may be performed by the server cluster 140 in the system shown in FIG. 1, where the server cluster is configured to provide backend support for an application program, the application program is provided with a virtual pet, and at least one pet image of the virtual pet is generated based on a genetic inheritance rule. As shown in FIG. 2, the method may include the following several steps:

Step 21. Receive a purchase request transmitted by a first terminal, the purchase request being used for requesting to purchase a first pet commodity.

The first pet commodity is a first virtual pet or a virtual prop used for obtaining the first virtual pet.

The virtual prop may be a prop used for directly or indirectly obtaining a corresponding virtual pet.

In some examples, the virtual prop may be used for triggering a terminal to display a Virtual Reality (VR) space, an Augmented Reality (AR) space or another type of three-dimensional virtual space, the three-dimensional virtual space includes a virtual pet in a capturable state, and after performing a capture operation and succeeding in capture, a user may obtain the virtual pet. Optionally, the virtual pet is a virtual cat, the virtual prop is a virtual cat bell, and after using the virtual cat bell, the user may capture the virtual cat in the AR space displayed by the terminal.

In some other examples, the virtual prop may be a virtual pet cage, a virtual pet case, a virtual pet parcel or the like used for obtaining a corresponding virtual pet, and after the virtual prop is used, the user directly obtains the virtual pet.

In some other examples, the virtual prop may be a prop that is used for a period of time to obtain a corresponding virtual pet, such as a pet egg, and after using the virtual prop, the user may obtain a corresponding virtual pet after the pet egg has been hatched for a period of time.

In some other examples, the virtual prop may be a prop used for granting a user a designated task, and after completing the designated task, the user may obtain the virtual pet.

In this embodiment of this disclosure, a pet commodity may be a virtual pet sold by a system.

Alternatively, the foregoing pet commodity may be a virtual prop that is sold by the system and that is used for obtaining a virtual pet.

Alternatively, the foregoing pet commodity may be a virtual pet sold by a user.

Alternatively, the foregoing pet commodity may be a virtual prop that is sold by the user and that is used for obtaining a virtual pet.

Subsequent embodiments of this application are illustrated respectively by using examples in which a pet commodity is a virtual prop that is sold by a system and that is used for obtaining a virtual pet, and a pet commodity is a virtual pet sold by a user, but this is not limited.

Step 22. Obtain first verification information according to the purchase request, the first verification information being first type information that is stored in a blockchain system and that is used for indicating validity of the purchase request.

In this embodiment of this disclosure, the foregoing purchase request may include information such as a first account and an identifier of the first pet commodity that is requested to be purchased.

The first account may be an account logging in to the first terminal and initiating the purchase request. For example, the first account include at least one of a username, a mobile phone number of a user or an application program account of a user.

The identifier of the first pet commodity may uniquely identify the first pet commodity in the blockchain system. For example, the identifier of the first pet commodity may be the serial number or the gene sequence of the first pet commodity.

After receiving the purchase request, the server cluster may search the blockchain system for the foregoing first type information according to the information included in the purchase request, such as the first account and the identifier of the first pet commodity.

Step 23. Transfer ownership of the first pet commodity from a second account to a first account when the first verification information indicates that the purchase request is valid.

The second account is an account selling the first pet commodity. When the first pet commodity is sold by a system, the second account may be a system account; or when the first pet commodity is sold by a user, the second account may be a user account.

The foregoing validity means that the corresponding request is allowed by the system to be performed. When the server cluster determines, through the first verification information, that the purchase request is valid, the server cluster may control completion of trading the pet commodity, to transfer the ownership of the first pet commodity from the second account to the first account.

Optionally, when the purchase of the first pet commodity needs to consume some resources, before transferring the ownership of the first pet commodity, the server cluster further performs a resource deduction operation, that is, deducts resources required for purchasing the first pet commodity from resources owned by the first account.

The foregoing resource may be a resource defined by the system or a resource allowed to be used. For example, the foregoing resource may be real currency, virtual currency, or credits. A specific representation form of the foregoing resource is not limited in this embodiment of this disclosure.

After completing the transfer of the ownership of the first pet commodity, the server cluster may notify related terminals (such as, the first terminal and the second terminal to which the second account logs in).

Alternatively, when the server cluster determines, according to the first verification information, that the purchase request is invalid, the server cluster may send a trading failure data response back to the first terminal, to prompt the first terminal display a trading failure indication.

The blockchain system is a computer system constructed based on a blockchain technology. The blockchain technology is a new distributed infrastructure and computing method that verifies and stores data by using a blockchain data structure, generates and updates data by using a distributed node consensus algorithm, ensures the security of data transmission and access by using a method of cryptology, and programs and operates data by using a smart contract formed by automation script code. The blockchain technology features information tamper-proof. Once information is verified and stored in the blockchain system, the information is permanently stored. Only when more than 51% of nodes in the system consent and confirm, the information in the system can be modified, and it is invalid to modify the information on a single node. Therefore, stability and reliability of data in the blockchain system are extremely high.

In this embodiment of this disclosure, after receiving a pet commodity purchase request transmitted by the terminal, the server cluster obtains the verification information with extremely high stability and reliability from the blockchain system to verify validity of the request, and trades a pet commodity after the verification is valid, thereby greatly improving security of trading a virtual pet.

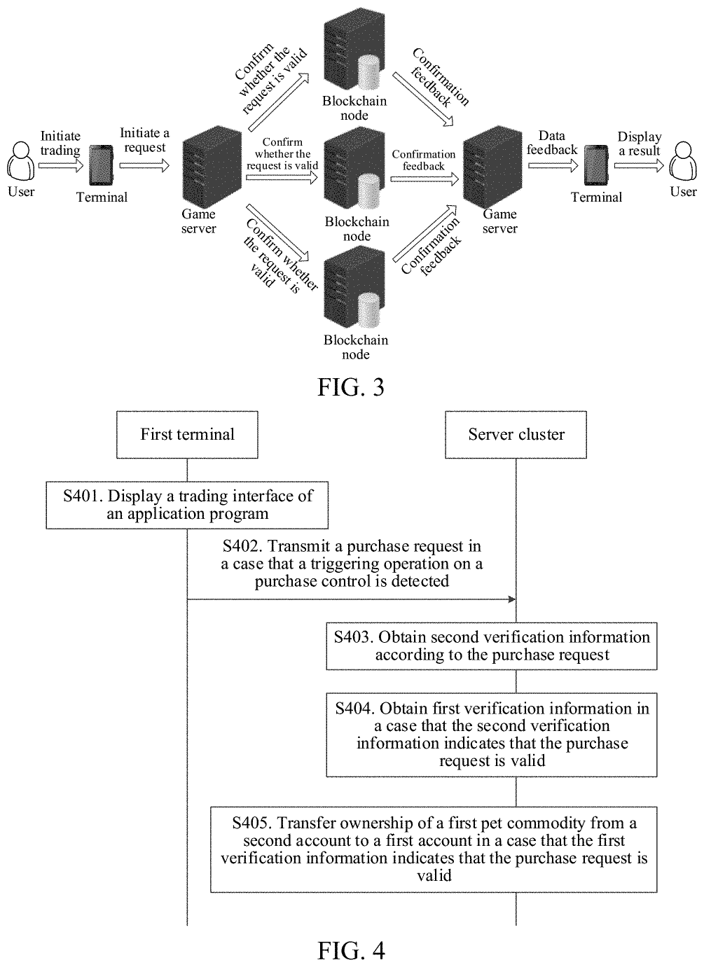

For example, FIG. 3 is a flowchart of trading a virtual pet involved in an embodiment of this disclosure. As shown in FIG. 3, using an example in which the application program is a game program providing a virtual pet and the server cluster is a game server, a user initiating a trading (such as, purchase request) operation through a terminal, the terminal transmits a request to the game server, and the game server confirms, to each node of a blockchain, whether the request is valid. When each node performs data confirmation and transmits a feedback on the validity of the request, the game server transmits a data feedback to the terminal according to the feedback transmitted by each node of the blockchain, to help the terminal display a trading result that the trading succeeds or fails.

FIG. 4 is a method flowchart of a method for trading a virtual pet commodity according to an exemplary embodiment of this disclosure. The method may be performed by the terminal 120 and the server cluster 140 in the system shown in FIG. 1, where an application program is installed in the terminal, the server cluster is configured to provide backend support for the application program, the application program is provided with a virtual pet, and at least one pet image of the virtual pet is generated based on a genetic inheritance rule. As shown in FIG. 4, the method may include the following several steps:

Step S401. A first terminal displays a trading interface of the application program, the trading interface including a purchase control of a first pet commodity.

The first pet commodity is a first virtual pet or a virtual prop used for obtaining the first virtual pet.

The application program providing a virtual pet is installed in the first terminal, and a first account logs in to the first terminal. Interfaces of the application program include the trading interface used for performing pet article trading. According to different types and functions of to-be-traded pet articles, the trading interface may include a plurality of labels, and each label is used for displaying different types of first pet commodities. For example, according to different types, the trading interface may include a label used for displaying a virtual pet being currently on sale, a label used for displaying a virtual pet being currently provided for matching, a label used for displaying a pet prop being currently on sale, a label used for displaying a virtual pet that will be available for sale, a label used for displaying all virtual pets and a label used for displaying a virtual pet or pet prop traded by a current user account.

In this embodiment of this disclosure, under the label corresponding to the first pet commodity, a purchase entrance of the first pet commodity may be displayed, and the purchase entrance may include the purchase control of the first pet commodity.

Alternatively, the purchase entrance may not include the purchase control of the first pet commodity, but a purchase interface triggered and entered through the purchase entrance includes the purchase control.

Alternatively, the foregoing purchase entrance and the purchase interface triggered and entered through the purchase entrance may each include the purchase control.

Optionally, the purchase control of the first pet commodity may further include various information about the first virtual pet, such as image, price, icon, name and characteristic.

Optionally, the foregoing trading interface provides a selecting control, and the selecting control is configured to display pet commodities according to a designated condition or order.

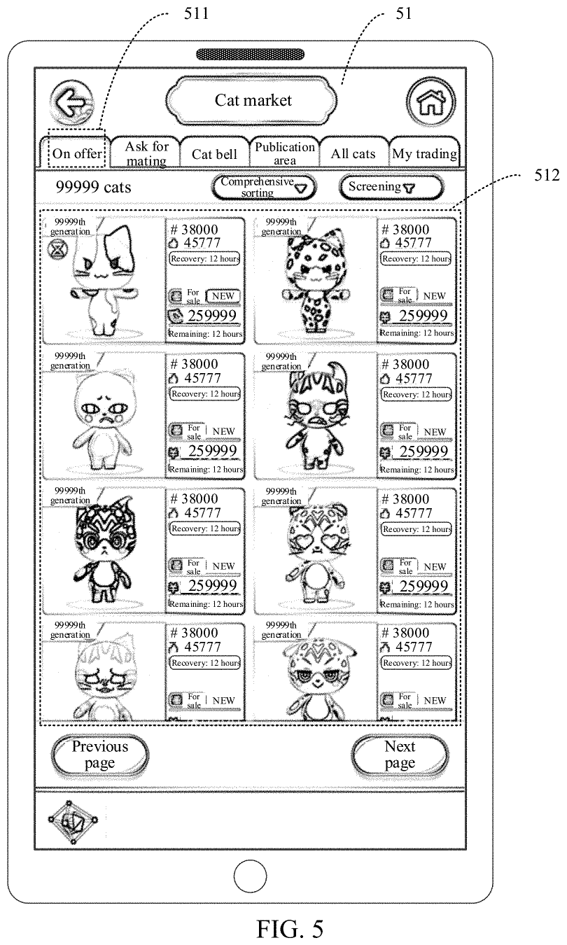

For example, the first pet commodity may be a virtual cat, or a cat bell used for obtaining a virtual cat, and the purchase interface entered from the purchase entrance of the first pet commodity includes the purchase control. Reference is made to FIG. 5 to FIG. 9.

When the first pet commodity is a virtual cat that a user releases and sells, FIG. 5 is a schematic diagram of a trading interface of a virtual cat in an embodiment of this disclosure. As shown in FIG. 5, the trading interface 51 includes such 6 labels as “on offer”, “asking for matching”, “cat bell”, “publicity area”, “all cats”, and “my trading”, where a purchase entrance 512 of virtual cats on offer is displayed under the “on offer” label 511, and a purchase entrance of each virtual cat may display the following information about the corresponding virtual cat: image, generation, serial number, the number of likes, recovery time, sale tag icon, new release tag icon, price, remaining time for sale, in-recovery tag and the like.

Moreover, under the foregoing “on offer” label, a total quantity of virtual cats being currently on sale is further displayed.

As shown in FIG. 5, under the foregoing “on offer” label, each page may display 50 virtual cats. When a player taps a next page, the server cluster may pull data of the following 50 virtual cats from the blockchain system, and transmit the data to the terminal for display.

As shown in FIG. 5, under the foregoing “on offer” label, all virtual cats on offer may be sorted in descending/ascending order of serial numbers (sorted comprehensively), order/reversed order of generations, order/reversed order of prices, descending order of the number of likes, or order/reversed order of recovery times.

Moreover, in the interface shown in FIG. 5, under the foregoing “on offer” label, virtual cats may be further filtered according to a condition such as an ordinary cat, or a dream cat (a cat owning a global characteristic); a precise generation may be obtained through screening (that is, only cats of a certain generation are displayed); or cats may be screened in order of recovery durations such as less than 2 hours, less than 1 day, less than 1 week, and greater than 1 week.

The foregoing recovery duration may be a duration required for a virtual cat to perform matching next time, and the recovery duration may be fixed, or may be increased or reduced according to an increase in a quantity of matching times of a virtual cat.

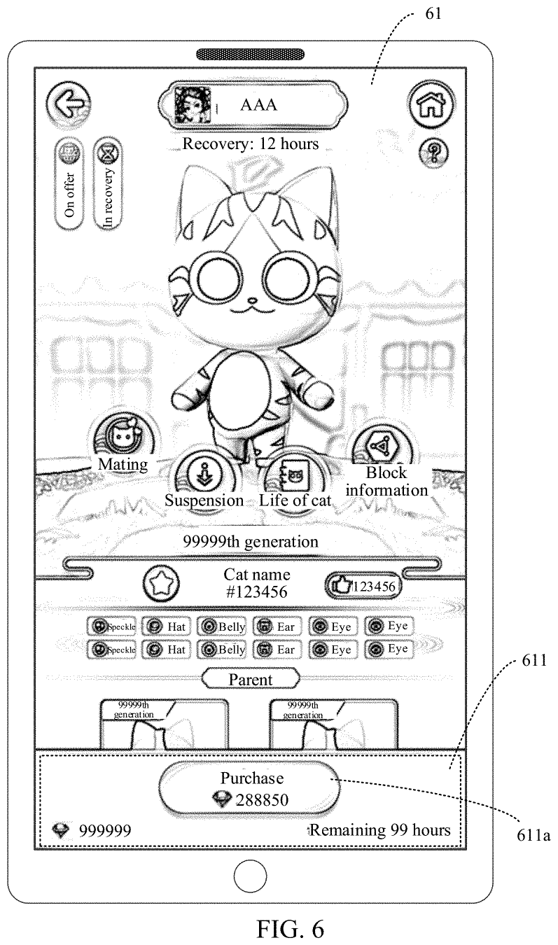

After the user taps a purchase entrance of a virtual cat under the “on offer” label in FIG. 5, the terminal may display a purchase interface of the corresponding virtual cat. FIG. 6 is a schematic diagram of a purchase interface of a virtual cat involved in an embodiment of this disclosure. As shown in FIG. 6, in a purchase interface 61 of a virtual cat, information about a displayed virtual cat is similar to a virtual cat detail interface of the virtual cat displayed in a backpack of an owner. Regardless of whether a user views a virtual cat sold by the user himself/herself or a cat sold by another user, information displayed in the purchase interface is similar to that in an display interface in which the user views his/her own virtual cat. For example, the purchase interface shown in FIG. 6 includes an image of a virtual cat, a sale state, a recovery state, a recovery time, a nickname and an avatar of a user to whom the virtual cat belongs, a generation, a name, a the number of likes, a name, a characteristic, parental images, a control used for displaying matching information of the virtual cat, a control used for displaying block information of the virtual cat, and a control used for displaying experience of the virtual cat.

As shown in FIG. 6, different from the virtual cat detail interface of the virtual cat displayed in the backpack of the owner, the purchase interface of the virtual cat further includes a purchase function bar part 611. A quantity of currency currently owned by a login account (that is, the first account) is displayed in a lower left corner of the part, a purchase button 611a (that is, the foregoing purchase control) is displayed in the upper middle, a current price of this virtual cat is displayed below the purchase button, and the time in which this virtual cat will be automatically suspended is displayed in a lower right corner.

As shown in FIG. 6, in addition to the purchase function bar part, the purchase interface of the virtual cat further includes a suspension control through which the user controls suspension of the virtual cat to unlist it from sale. If the virtual cat viewed by the login account belongs to the login account, the foregoing purchase button cannot be tapped, while the suspension control can be tapped; or if the virtual cat viewed by the login account does not belong to the login account, the foregoing purchase button can be tapped, while the suspension control cannot be tapped.

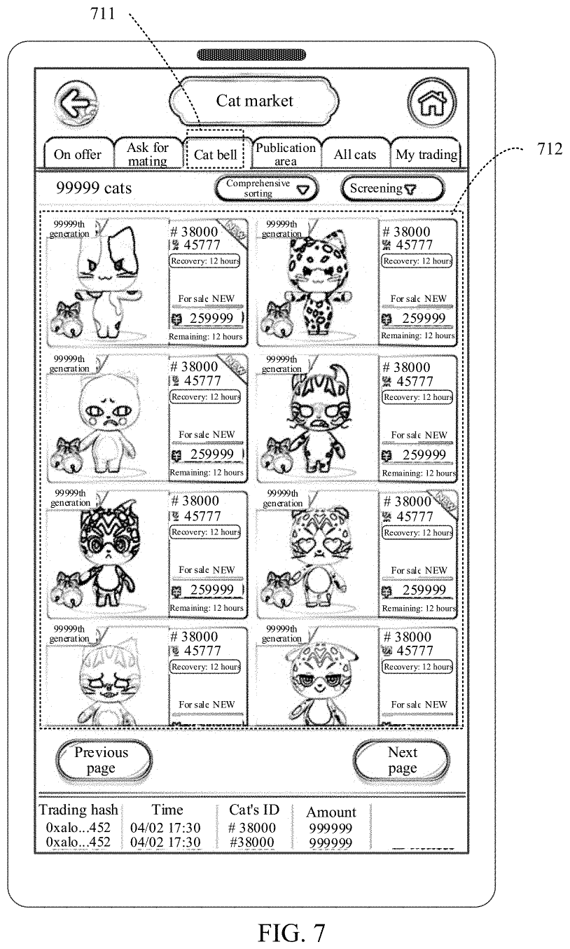

When the first pet commodity is a cat bell of a virtual cat that a user releases and sells, FIG. 7 is a schematic diagram of a purchase interface of a cat bell involved in an embodiment of this disclosure. In FIG. 7, a purchase entrance 712 of each cat luring bell (i.e., the foregoing cat bell) sold by a system is displayed under a “cat bell” label 711, and a purchase entrance of each cat luring bell may display the following information about a corresponding virtual cat: an image, a generation, a price and the like. Moreover, each cat luring bell further corresponds to a special serial number, and the serial number is a unique serial number of a corresponding virtual cat. After tapping a purchase entrance of a cat bell, the user enters a purchase interface of the cat luring bell.

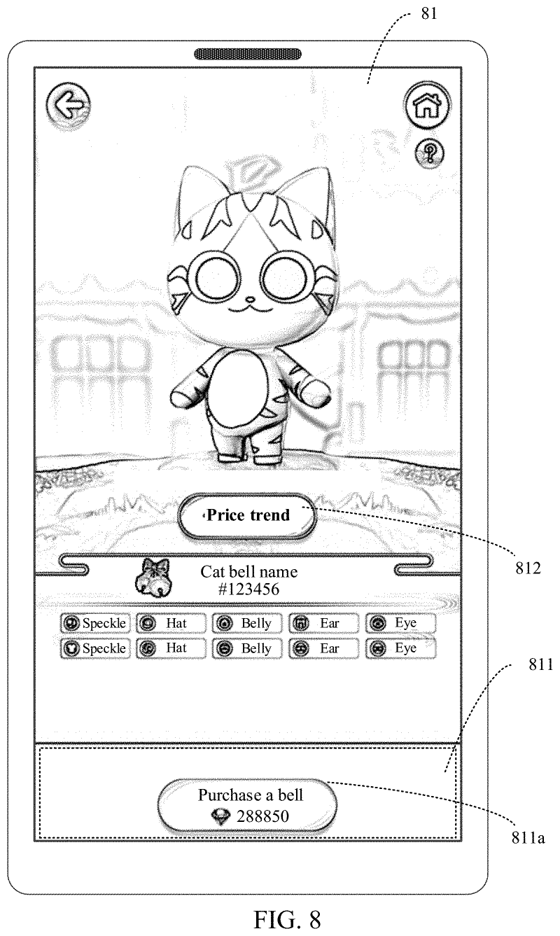

FIG. 8 is a schematic diagram of a purchase interface of a cat luring bell involved in an embodiment of this disclosure. As shown in FIG. 8, the purchase interface 81 of the cat luring bell includes information such as an image of a cat corresponding to the bell, a price trend button 812, a bell icon, a bell name, and a characteristic of the corresponding virtual cat. A purchase bar 811 below the purchase interface of the cat luring bell further includes a purchase button 811a, and the purchase button may display a price of the cat luring bell.

Optionally, the first terminal may further display the price trend control (such as the price trend button 812 shown in FIG. 8) of the first pet commodity in the trading interface when the first pet commodity is a virtual pet or pet prop sold by the system; and display a price trend interface of the first pet commodity when a triggering operation on the price trend control is detected, where the price trend interface displays a price of the first pet commodity at each time point after the first pet commodity is released. The time points may be predefined in any manner. For example, the time points may be periodic with a periodicity of, e.g., every minute, every 10 minutes, every hour, or the like. The time point may also be a time instant when the price of the first pet commodity changes.

For example, as shown in FIG. 7, the system releases a batch of new cat luring bells once every predefined time interval, for example, at 6:00 am every morning. The release time and the quantity of each batch of released cat luring bells may be determined according to configurations performed by a developer in the system.

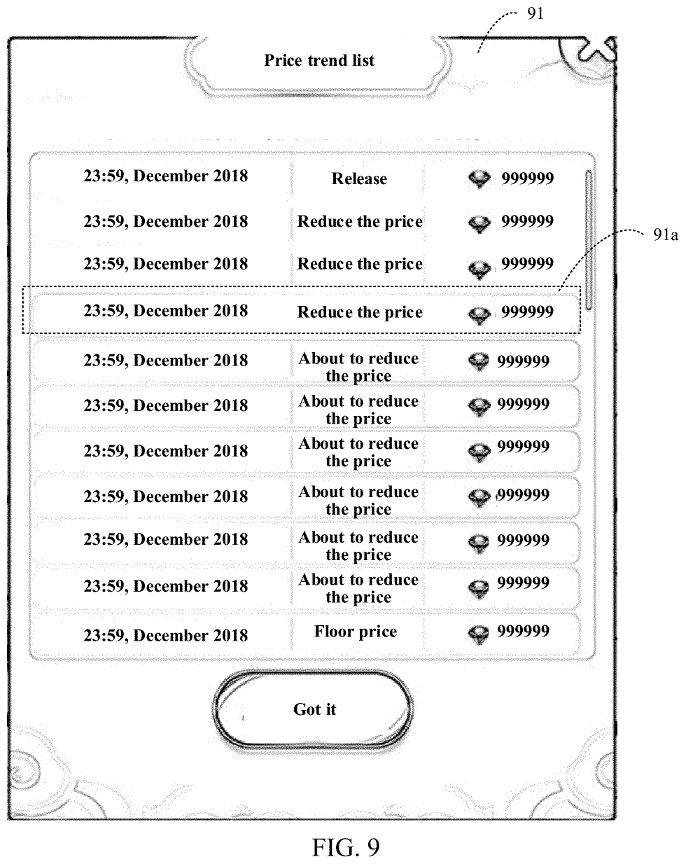

In a configuration, prices of the foregoing cat luring bells may be determined by the market. For example, the system sets a floor price of cat luring bells, and prices of a first batch of cat luring bells are all the floor price. Starting from an N^{th} cat luring bell, a price of a newly released cat luring bell is an average transaction price of first N cat luring bells multiplied by M %. N and M herein may be configured by operation personnel or a developer. Optionally, starting from release, the price of the cat luring bell gradually decreases. For example, at each time interval of X, the price of the cat luring bell decreases by Y, and decreases to the floor price after Z times of price reduction, where X, Y, and Z are also configured by the operation personnel or the developer. A price trend of the cat luring bell may be viewed in the corresponding price trend interface. For example, FIG. 9 is a schematic diagram of a price trend involved in an embodiment of this disclosure. As shown in FIG. 9, a price trend interface 91 displays a release time of a cat luring bell, a release price, and a time and a price of each time of price reduction. Moreover, a price reduction range (that is, an area shown by a dashed box 91a in FIG. 9) to which a price of a current virtual cat belongs is further highlighted, to help a user determine whether to make a decision on purchase.

Step S402. The first terminal transmits a purchase request to a server cluster when a triggering operation on the purchase control is detected, and the server cluster receives the purchase request.

Optionally, after the user corresponding to the first terminal taps the purchase control included in the trading interface, the first terminal may display a re-confirming interface; and after the user taps purchase confirming in the re-confirming interface, the first terminal transmits the purchase request to the server cluster.

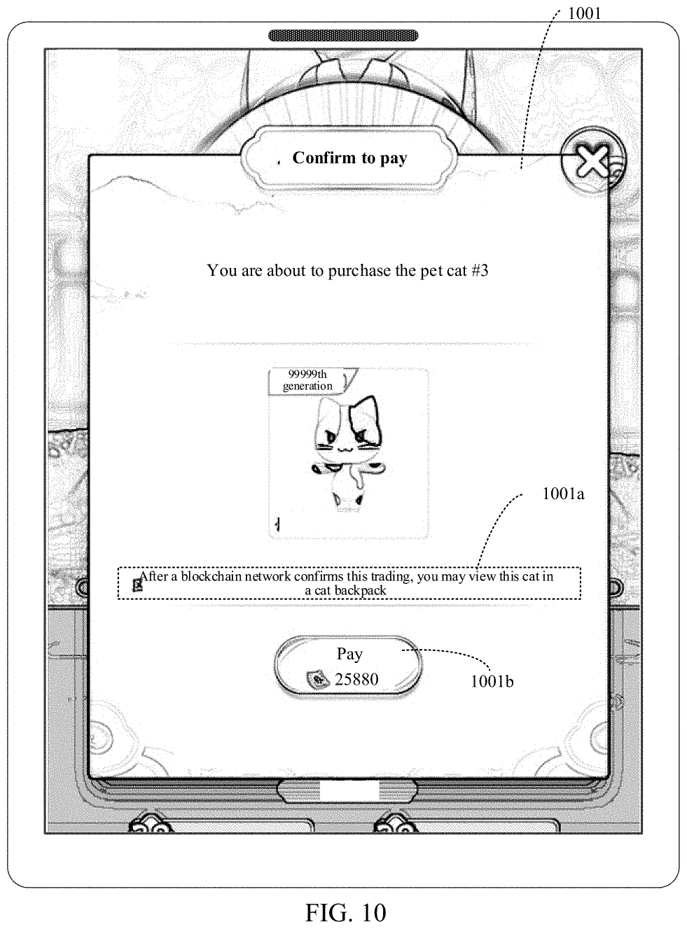

For example, when the first pet commodity is a virtual cat that a user releases and sells, FIG. 10 is a schematic diagram of a purchase confirming interface of a virtual cat involved in an embodiment of this disclosure. As shown in FIG. 10, a purchase confirming interface 1001 of a virtual cat specifically displays a serial number (the serial number is a credential of the virtual cat on a blockchain, and may be absolutely unique on the blockchain) of the virtual cat, a payment user identifier, a quantity of paid resources (that is, payment amount), an image of the virtual cat, a generation and blockchain information confirming prompt 1001a, a payment button 1001b and the like. After tapping the payment button 1001b, the user may enter a blockchain confirming step (refer to subsequent step S403 to step S405). Moreover, a trading prompt interface is displayed, where the trading prompt interface is used for prompting that trading is being performed.

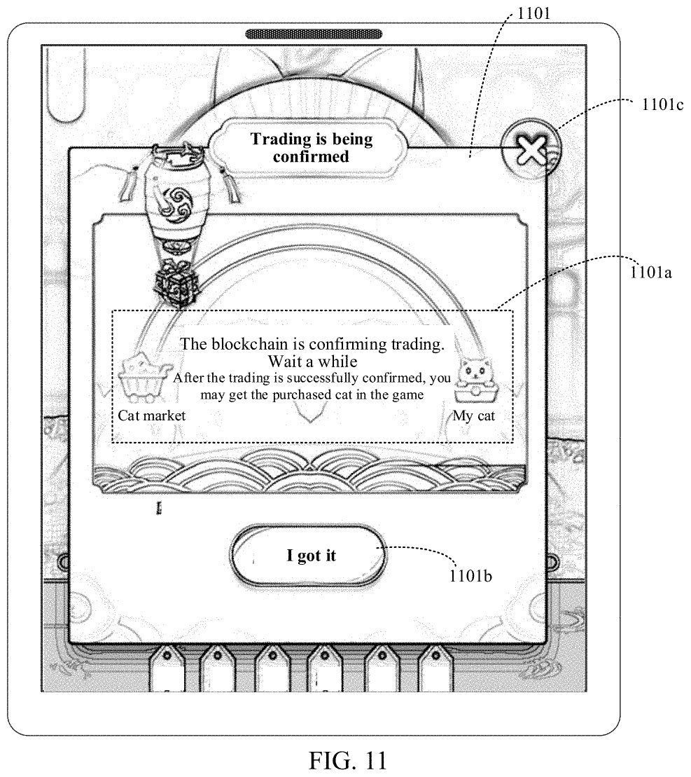

For example, FIG. 11 is a schematic diagram of a trading prompt interface involved in an embodiment of this disclosure. As shown in FIG. 11, the trading prompt interface 1101 displays prompt information 1101a, to prompt a user that blockchain trading confirmation is being performed, and the user may tap a confirming button 1101b or a closing button 1101c to close the trading prompt interface 1101.

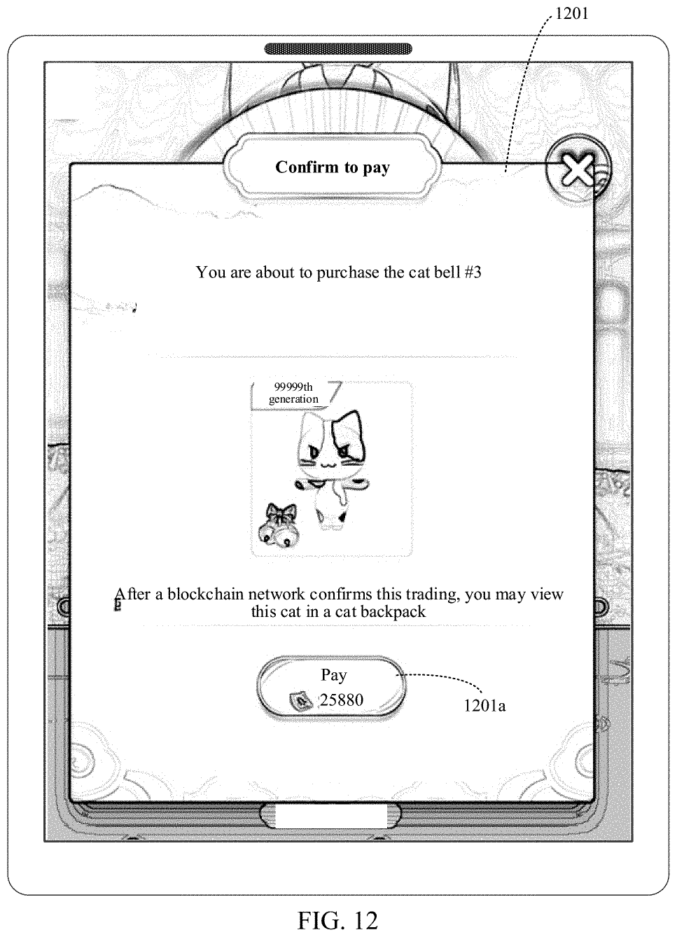

In another example, when the first pet commodity is a cat luring bell that a system releases and sells, FIG. 12 is a schematic diagram of a purchase confirming interface of a cat luring bell involved in an embodiment of this disclosure. As shown in FIG. 12, after a user taps a purchase control of a cat luring bell, a purchase confirming interface 1201 of the cat luring bell is displayed. The interface displays a serial number of a virtual cat, a payment user identifier, a quantity of paid resources, an image of the virtual cat, a generation and blockchain information confirming prompt, a payment button 1201a and the like. After tapping the payment button 1201a, the user may enter a blockchain confirming step. Moreover, a trading prompt interface is displayed.

Step S403. The server cluster obtains second verification information according to the purchase request, the second verification information being first type information that is stored out of the blockchain system and that is used for indicating the validity of the purchase request.

The first type information may include but is not limited to at least one of the following 6 types of information:

1. Whether the ownership of the first pet commodity is valid

The information indicates whether the first pet commodity is owned by the second account selling the first pet commodity. If the first pet commodity is owned by the second account, the purchase request is valid; otherwise, the purchase request is invalid.

2. Whether a price of the first pet commodity is valid

The information indicates whether the price of the first pet commodity falls within a valid range. When the price of the first pet commodity falls within the valid range, the purchase request is valid; otherwise, the purchase request is invalid.

3. Whether a salable state of the first pet commodity is valid

The information indicates whether the first pet commodity is in the salable state. When the first pet commodity is in the salable state, the purchase request is valid; otherwise, the purchase request is invalid.

For example, the first pet commodity is a virtual cat. When the virtual cat is not in a state of being used such as a matching state or a task assigned state, it may be considered that the virtual cat is in the salable state.

4. Whether the lock state of the first pet commodity is an unlocked state

The information indicates whether the first pet commodity is locked. When the first pet commodity is not locked, the purchase request is valid; otherwise, the purchase request is invalid.

The lock of the first pet commodity may be divided into user lock and system lock.

For example, the first virtual pet is a virtual cat. An owner of the virtual cat may lock the virtual cat from an interface such as an interface for displaying his/her own cats, so that the virtual cat cannot be traded. In one implementation, the interface may be a backpack interface where the backpack is used for holding the virtual cat. In this case, the virtual cat is locked. Alternatively, when the virtual cat is requested to be purchased by another user account in the trading interface but the purchase has not been completed, the server cluster may lock the trading of the virtual cat at the backend. In this case, the virtual cat is also in the locked state.

5. Whether the first account owns resources required for purchasing the first pet commodity

The information indicates whether the resources owned by the first account are sufficient to pay for purchasing the first pet commodity. For example, the first type information may include a quantity of the resources owned by the first account. When the quantity of the resources is greater than or equal to that of the resources required for purchasing the first pet commodity, the purchase request is valid; otherwise, the purchase request is invalid.

6. Whether the resources required for purchasing the first pet commodity are successfully deducted

The information indicates whether the server cluster has deducted the resources required for purchasing the first pet commodity from the resources owned by the first account. If yes, the purchase request is valid; otherwise, the purchase request is invalid.

Step S404. The server cluster obtains, when the second verification information indicates that the purchase request is valid, first verification information according to the purchase request, the first verification information being first type information that is stored in a blockchain system and that is used for indicating validity of the purchase request.

If validity of the purchase request is always determined through the first type information stored in the blockchain system, an excessively large pressure on the blockchain system may be caused by high frequency purchase requests. To avoid causing an unnecessary pressure on the blockchain system, and further improve verification accuracy, in this embodiment of this disclosure, before obtaining the first verification information stored in the blockchain system, the server cluster may first obtain the second verification information stored out of the blockchain system. When the second verification information indicates that the purchase request is invalid, the trading request may be rejected and a query through the blockchain system is skipped. Only when the second verification information indicates that the purchase request is valid, the subsequent step of obtaining the first verification information is performed.

Step S405. The server cluster transfers ownership of the first pet commodity from a second account to a first account when the first verification information indicates that the purchase request is valid.

The second account is an account selling the first pet commodity.

Optionally, when the first verification information indicates that the purchase request is valid, a lock state of the first pet commodity is set to a locked state before the transferring ownership of the first pet commodity from a second account to a first account.

Similar to the description of the lock state of the first pet commodity, because a particular time difference exists between the time of receiving the purchase request and the time of completing the trading, when a plurality of purchase requests for the same pet commodity are received in a short time, it is easy to cause repeated processing or repeated sale of the same pet commodity if all the purchase requests are processed. To solve this issue, in this embodiment of this disclosure, after determining the purchase request is valid according to the first verification information, the server cluster may set the lock state of the first pet commodity to the locked lock, and set a lock duration (such as 5 s). If the trading is not completed within 5 s, the server cluster sets the lock state of the first pet commodity to the unlocked state, and processes a next purchase request for the first pet commodity. If the trading is completed within 5 s, the server cluster may remove the first pet commodity from the trading interface. Optionally, the server cluster further transmits a trading completion prompt to the first account through a mail.

Optionally, the first terminal displays the first pet commodity in a pet display interface of the application program, the pet display interface being used for displaying a virtual pet owned by the first account.

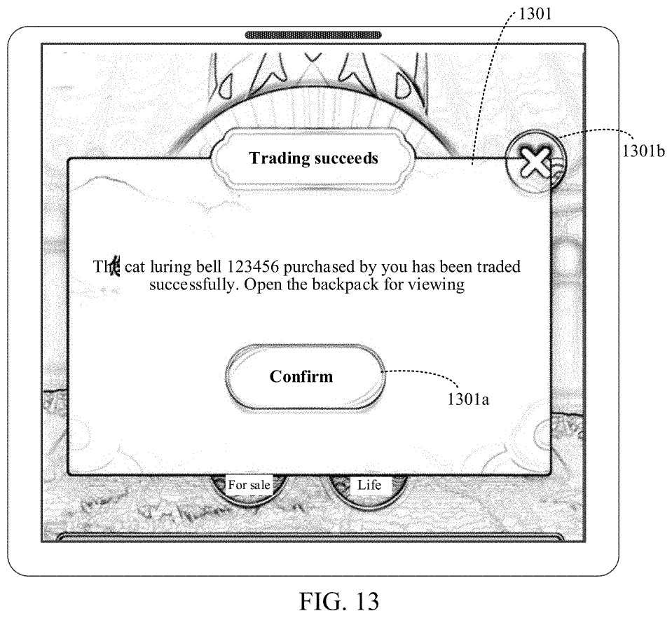

After the trading is completed, the terminal may transmit the first pet commodity to the first account, and the first terminal to which the first account logs in performs corresponding display. For example, FIG. 13 is a schematic diagram of a trading success prompt interface involved in an embodiment of this disclosure. As shown in FIG. 13, the trading success prompt interface 1301 includes a trading success prompt text, and a user may tap a confirming button 1301a or a closing button 1301b in the trading success prompt interface to close the interface.

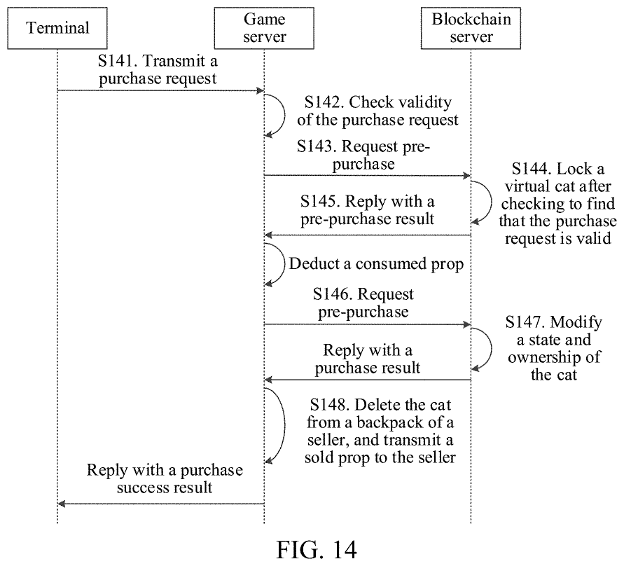

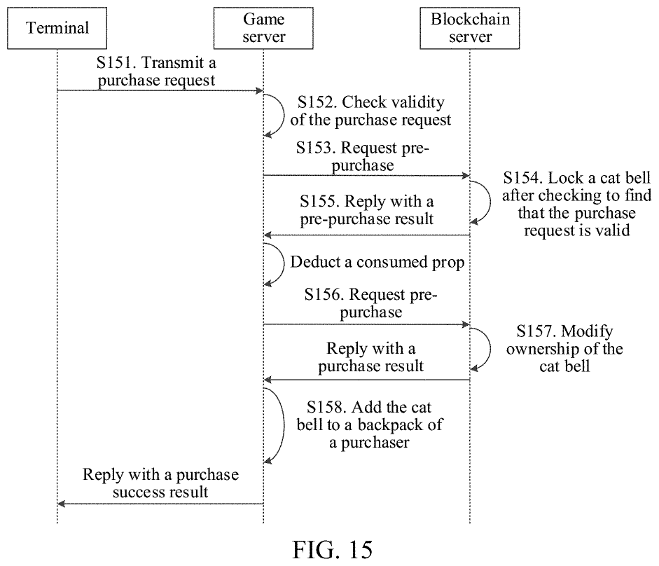

In another embodiment, for example, the first pet commodity may be a virtual cat or a prop such as a cat bell used for obtaining a virtual cat, the server cluster includes a game server and a blockchain server, and the purchase request is transmitted by a game client in the first terminal. Reference is made to FIG. 14 and FIG. 15.

FIG. 14 is a schematic flowchart of purchasing a virtual cat in an embodiment of this disclosure. As shown in FIG. 14, the process may include the following steps:

S141. A player taps to purchase a virtual cat in a market list, and a terminal transmits a purchase request to a game server.

S142. The game server checks validity of the purchase request, including validity of ownership of the cat, price validity, salable state validity, whether props to be consumed of a purchaser are sufficient and the like. It is to be noted that a player may make purchase using resources such as props owned by the player.

S143. After checking purchase validity, the game server requests pre-purchase from a blockchain server.

S144. The blockchain server re-checks validity of the order, and additionally verifies whether this cat is locked by another purchaser; and locks this cat for 5 seconds if the order placement is valid and the cat is in the unlocked state.

S145. The blockchain server replies to the game server with a pre-purchase result, and after receiving a pre-purchase result indicating the sale may proceed, the game server deducts from the player's account the consumption props needed for the sale.

S146. After deducting from the player's account the consumption props needed for purchasing the virtual cat, the game server requests purchase from the blockchain server.

S147. The blockchain server processes the purchase request, updates a trading state and ownership of the cat in the blockchain, then deletes this cat from the market, and finally replies to the game server with a purchase result.

Optionally, before processing the purchase request, the blockchain server re-checks the purchase validity, and further checks whether the consumption prop of the player is successfully deducted from the player's account, in addition to the validity of ownership of the cat, the price validity, the salable state validity, and whether props to be consumed of a purchaser are sufficient in the current detection.

S148. After receiving a purchase success result, the game server deletes this cat from a backpack of an original seller, transmits the props gained from the sale to a seller, sends a mail to inform the player that the purchase is successful, and finally replies to the purchaser with a purchase result.

FIG. 15 is a schematic flowchart of purchasing a cat bell involved in an embodiment of this disclosure. As shown in FIG. 15, the process may include the following steps:

S151. A player selects a cat bell in a cat bell market list, and taps to purchase the cat bell, and a terminal transmits a purchase request to a game server.

S152. The game server checks validity of this purchase trading, including validity of ownership of the cat bell, price validity, salable state validity, whether resources to be consumed of a purchaser are sufficient and the like.

S153. After checking purchase validity, the game server requests pre-purchase from a blockchain server.

S154. The blockchain server re-checks validity of the order, and additionally verifies whether this cat bell is locked by another purchaser; and locks this cat bell for 5 seconds if the order placement is valid and the cat bell is in the unlocked state.

S155. The blockchain server returns a pre-purchase result to the game server, and after receiving a pre-purchase result indicating the sale may proceed, the game server deducts from the player's account the consumption props needed for the sale.

S156. After deducting the consumption props from the player's account, the game server requests purchase from the blockchain server.

S157. The blockchain server processes the purchase request, modifies a trading state and ownership of the cat bell in the blockchain, then deletes this cat bell from the market, and finally replies to the game server with a purchase result.

Optionally, before processing the purchase request, the blockchain server re-checks the purchase validity, and further checks whether the consumption props is successfully deducted from the player's account in addition to the validity of ownership of the cat, the price validity, the salable state validity, and whether to-be-consumed props of a purchaser are sufficient in the current detection.

S158. After receiving a purchase success result, the game server adds this cat bell to a prop backpack of the player, sends a mail to inform the player that the purchase is successful, and finally replies to the purchaser with a purchase result.

To sum up, in the solution shown in this embodiment of this disclosure, after receiving a pet commodity purchase request transmitted by the terminal, the server cluster obtains the verification information with extremely high stability and reliability from the blockchain system to verify validity of the request, and trades a pet commodity after the verification is valid, thereby greatly improving security of trading a virtual pet.

Moreover, in the solution shown in this embodiment of this disclosure, before obtaining the verification information from the blockchain system, the server cluster first obtains the same type of verification information out of the blockchain system, and obtains, after the verification is valid, the verification information from the blockchain system to verify validity of the request, to avoid causing an unnecessary pressure on the blockchain system, and further improve verification accuracy.

If the second account selling the first pet commodity is a user account rather than a system account, only when a user corresponding to the second account performs a release operation on the first pet commodity, the server cluster may release the first pet commodity (i.e., add or list the first pet commodity to the trading interface), and the release process also needs to be verified.

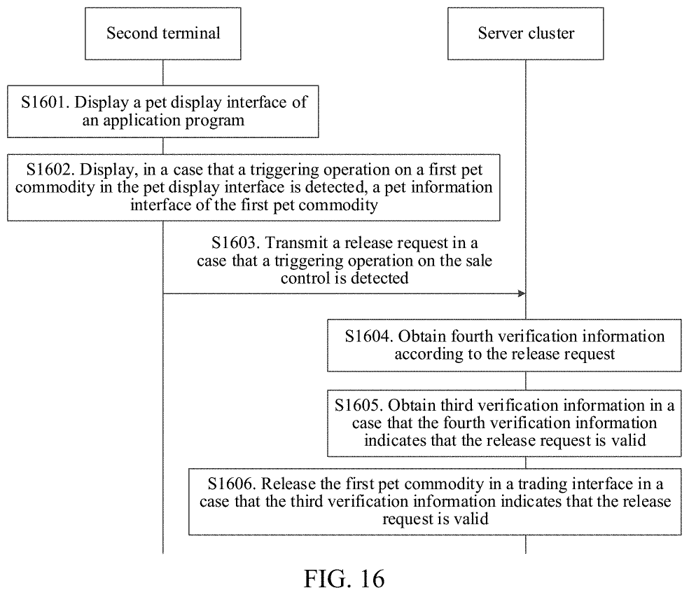

FIG. 16 is a method flowchart of a method for trading a virtual pet commodity according to an exemplary embodiment of this disclosure. The method may be performed by the terminal 120 and the server cluster 140 in the system shown in FIG. 1, where an application program is installed in the terminal, the server cluster is configured to provide backend support for the application program, the application program is provided with a virtual pet, and at least one pet image of the virtual pet is generated based on a genetic inheritance rule. As shown in FIG. 16, the method may include the following several steps:

Step S1601. A second terminal displays a pet display interface of the application program, the pet display interface being used for displaying a pet commodity owned by a second account, and the second account being an account logging in to the terminal.

In this embodiment of this disclosure, after a user performs an operation of turning on the pet display interface (for example, a backpack), the terminal may display the pet display interface, where the pet display interface may display pet commodities owned by the user (for example, a virtual cat and a cat luring bell).

Step S1602. The second terminal displays, when a triggering operation on a first pet commodity in the pet display interface is detected, a pet information interface of the first pet commodity.

The pet information interface of the first pet commodity includes a sale control of the first pet commodity, and the first pet commodity is a first virtual pet or a virtual prop used for obtaining the first virtual pet.

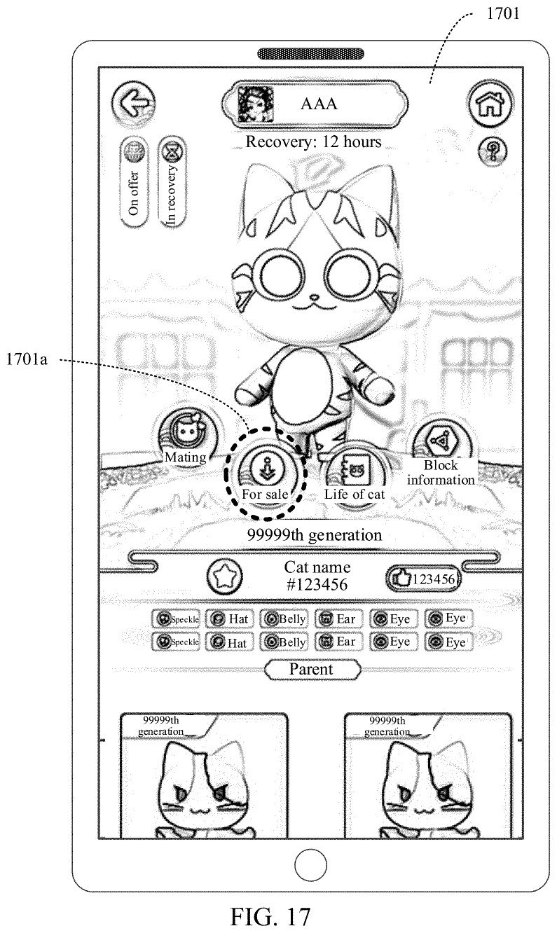

For example, FIG. 17 is a schematic diagram of a pet information interface of a virtual cat in an embodiment of this disclosure. As shown in FIG. 17, information displayed in the pet information interface 1701 of the virtual cat is similar to information in the purchase interface of the virtual cat shown in FIG. 6. Different from FIG. 6, in FIG. 17, when the virtual cat is not released, the pet information interface of the virtual cat does not include a purchase bar, but instead includes a sale control 1701a.

Step S1603. The second terminal transmits a release request to a server cluster when a triggering operation on the sale control is detected, and the server cluster receives the release request.

The release request is used for requesting to release and sell the first pet commodity.

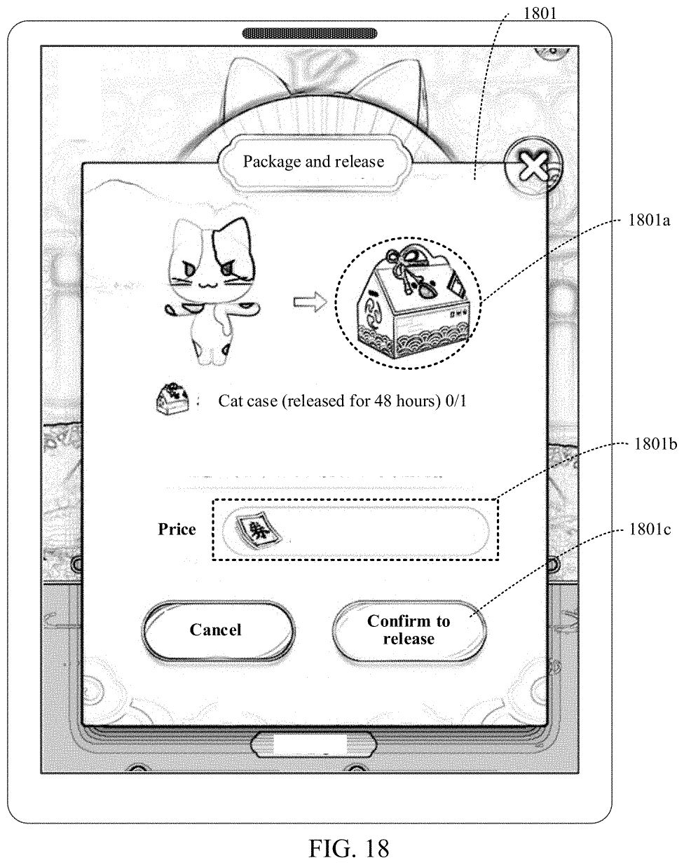

For example, based on the schematic diagram of the pet information interface of the virtual cat shown in FIG. 17, after the user triggers the sale control in FIG. 17, the second terminal may display a release confirming interface. FIG. 18 is a schematic diagram of a release confirming interface in an embodiment of this disclosure. In the release confirming interface 1801 shown in FIG. 18, if the player releases a virtual cat for sale, a prop (e.g., a cat case 1801a in FIG. 18) needs to be consumed as the cost for releasing (or listing) the virtual cat, where the prop may be generated in the game, and may be purchased or exchanged with game currency. The time period for how long a virtual cat is released is limited to a designated time in the game, and the limited time is designed to reduce the communication pressure on a blockchain network if nobody purchases the released virtual cat in an excessively long time. The price of the virtual cat may be self-defined by the player. Optionally, upper limit or lower limit may or may not be set. The user may set the price in a price setting box 1801b. After the virtual cat is successfully sold, the system may collect a proportion of the sale price as a handling charge for blockchain information change, and the proportion may be determined by a configuration of the system. After the player finalize the price and consumes a corresponding prop for listing the virtual cat, a large map animation is played if the player taps a release confirming button 1801c. In the process of playing the animation, the blockchain network has been confirming this release. After the blockchain network completes the confirmation, this cat appears in the market. Refer to subsequent steps S1604 to S1606 for the confirming process of the blockchain.

Step S1604. The server cluster obtains fourth verification information according to the release request, the fourth verification information being second type information that is stored out of the blockchain system and that is used for indicating validity of the release request.

The second type information includes at least one of the following several types of information:

1. Whether the ownership of the first pet commodity is valid.

The information indicates whether the first pet commodity is owned by the second account selling the first pet commodity. If the first pet commodity is owned by the second account, the release request is valid; otherwise, the release request is invalid.

2. Whether a price of the first pet commodity is valid.

The information indicates whether the price of the first pet commodity falls within a valid range. When the price of the first pet commodity falls within the valid range, the release request is valid; otherwise, the release request is invalid.

3. Whether a salable state of the first pet commodity is valid.

The information indicates whether the first pet commodity is in the salable state. When the first pet commodity is in the salable state, the release request is valid; otherwise, the release request is invalid.

4. Whether the second account owns resources required for releasing the first pet commodity.

The information indicates whether the resources owned by the second account are sufficient to pay for releasing the first pet commodity. For example, the second type information may include a quantity of the resources owned by the second account. When the quantity of the resources is greater than or equal to that of the resources required for releasing the first pet commodity, the release request is valid; otherwise, the release request is invalid.

5. Whether a mailbox of the second account is full.

The information indicates whether the mailbox of the second account has capacity to receive a notification mail. If yes, the release request is valid; otherwise, the release request is invalid.

6. Whether the resources required for releasing the first pet commodity are successfully deducted.

The information indicates whether the server cluster has deducted the resources required for releasing the first pet commodity from the resources owned by the second account. If yes, the release request is valid; otherwise, the release request is invalid.

Step S1605. The server cluster obtains, when the fourth verification information indicates that the release request is valid, third verification information according to the release request, the third verification information being second type information that is stored in a blockchain system and that is used for indicating validity of the release request.

Similarly, if validity of the release request is always determined through the second type information stored in the blockchain system, an excessively large pressure on the blockchain system may be caused by high frequency release requests. To avoid causing an unnecessary pressure on the blockchain system, and further improve verification accuracy, in this embodiment of this disclosure, before obtaining the third verification information stored in the blockchain system, the server cluster may first obtain the fourth verification information stored out of the blockchain system. When the fourth verification information indicates that the release request is invalid, the release request may be rejected and a query through the blockchain system is skipped. Only when the fourth verification information indicates that the release request is valid, the subsequent step of obtaining the third verification information is performed.

Step S1606. Release the first pet commodity in a trading interface when the third verification information indicates that the release request is valid.

Optionally, the server cluster adds, when the third verification information indicates that the release request is valid, an information display control of the first pet commodity to a publicity area in the trading interface, where each virtual pet in the publicity area is in a trading prohibited state, and the information display control is used for displaying information about the corresponding virtual pet; and adds a purchase entrance of the first pet commodity to a trading area in the trading interface when a valid display duration of the information display control of the first pet commodity in the publicity area reaches a preset duration.

The cat released by the player may not enter a salable state right away, but goes through a particular publicity period. The duration of the publicity period may also be adjusted by the system according to an operating requirement.

For example, FIG. 19 is a schematic diagram of displaying a publicity area involved in an embodiment of this disclosure. As shown in FIG. 19, a viewing entrance 1902 for virtual cats about to enter a salable state is displayed under a “publicity area” label 1901, a viewing entrance of each virtual cat may display an image, a generation, a serial number, a the number of likes, a recovery time, a price and a publicity label of the corresponding virtual cat. After a user taps the viewing entrance of the virtual cat, an interface showing the detail of the virtual cat may be displayed, the detail interface may not include a purchase bar or include a purchase bar, but a purchase button in the purchase bar is in an unavailable/inactive state. At a publicity stage after virtual cats are released, all players may view the virtual cats, but cannot purchase the virtual cats. Only after the publicity period expires, the virtual cats enter the salable state, and are displayed under an “on offer” label.

The publicity rule is designed to raise the threshold of performing point-to-point trading in the trading market, to avoid a case of trading online at a low price and profiteering offline at a high price among players to the maximum extent.

The countdown is not displayed in the publicity period of time, to increase costs of determining the end of the publicity period by a player.

Optionally, the valid display duration is a display duration in a designated time period in each predetermined cycle.

In one implementation, the foregoing predetermined cycle may be one day (24 hours), the designated time period may be an active trading period in each day, and correspondingly, time periods other than the designated time period are inactive trading periods in each day.

In some examples, a curfew rule may be designed for the publicity area. For example, a predetermined cycle may be 24 hours starting from 0 o'clock every day. Between 0 o'clock and 6 o'clock in the morning, the publicity area is in a curfew state. In this case, designated time periods for valid display may be time periods out of curfew state. A virtual pet still in publicity in the curfew time periods may only be released from a publicity state after 6 o'clock in the morning. For example, assuming that the publicity period is 2 hours, a virtual pet entering publicity after 22 o'clock may be purchased only after 6 o'clock the next day, after the curfew period ends. If a virtual pet is released and publicized in the curfew time, the publicity time during curfew period is considered invalid. The virtual pet may enter a sale state only after the virtual pet satisfies the valid publicity period of time. Such design mainly aims to eliminate point-to-point trading when there are fewer active users before dawn.

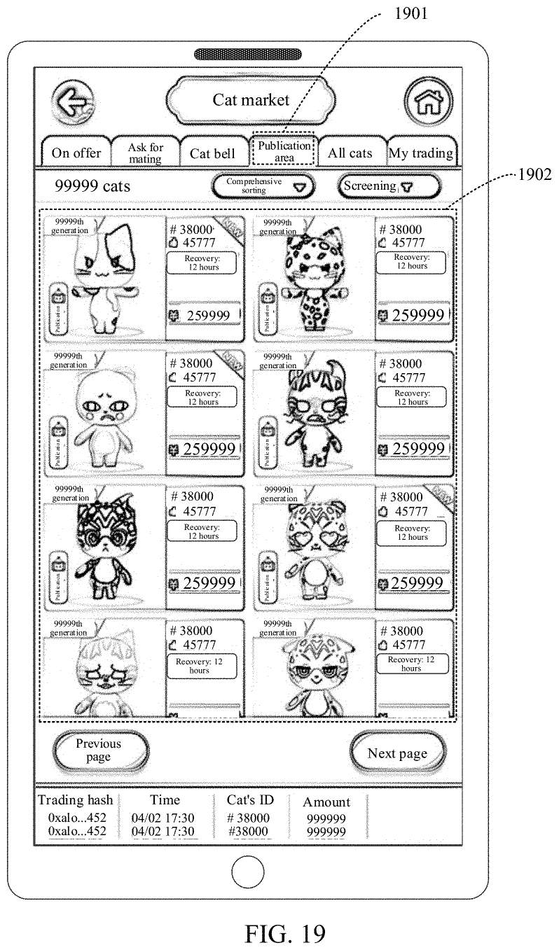

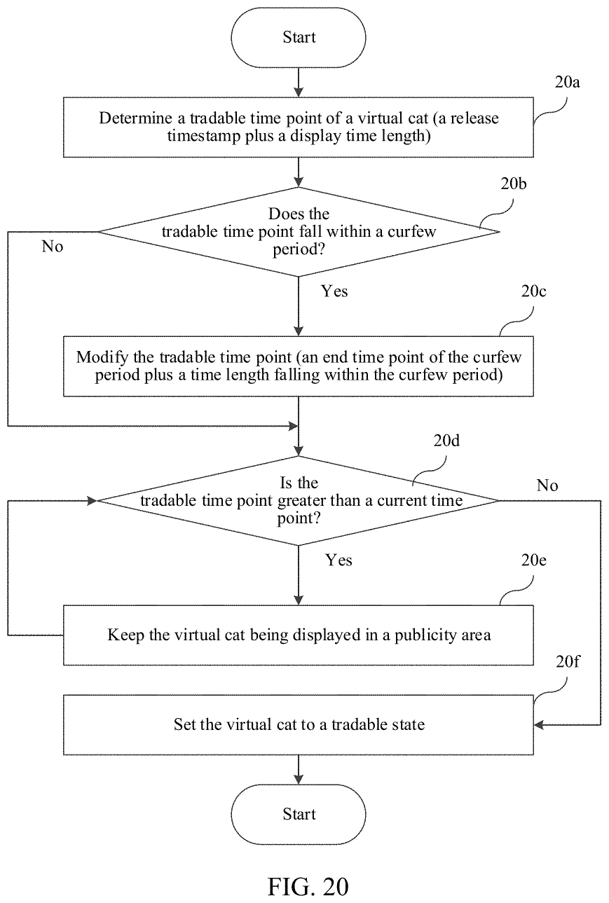

FIG. 20 is a schematic diagram of a release display logic involved in an embodiment of this disclosure. As shown in FIG. 20, using an example in which a virtual pet is a virtual cat, a release display process of the virtual cat may be as follows:

Step 20a. After confirming that a virtual cat is released, a server cluster determines a tradable time point at which the virtual cat may begin to be traded, the tradable time point being a release timestamp plus a publicity display duration, where the release timestamp may be a time point at which the server cluster confirms that the virtual cat may be released. For example, when a user releases a virtual cat out of a curfew period, the release timestamp may be a time point at which the server cluster verifies that a release request is valid. The foregoing display duration is a duration of a publicity period.

Step 20b. The server cluster determines whether the tradable time point falls within the curfew period (that is, beyond the foregoing designated time period). If yes, step 20c is performed; otherwise, step 20d is performed.

Step 20c. Modify the tradable time point if the server cluster determines that the tradable time point falls within the curfew period. For example, the tradable time point before modification is T. The server first calculates a duration L as the display duration falls within the curfew period, and sets a tradable time point after the modification to an end time point of the curfew period plus the duration L.

Step 20d. The server cluster determines whether the tradable time point is greater than a current time point. If yes, step 20e is performed; otherwise, step 20f is performed.

Step 20e. The server cluster continues to keep the virtual cat being displayed in the publicity area, to display the virtual cat under a “publicity area” label.

Step 20f. The server cluster sets the virtual cat to a tradable state. For example, the virtual cat is transferred from the “publicity area” label to an “on offer” label.

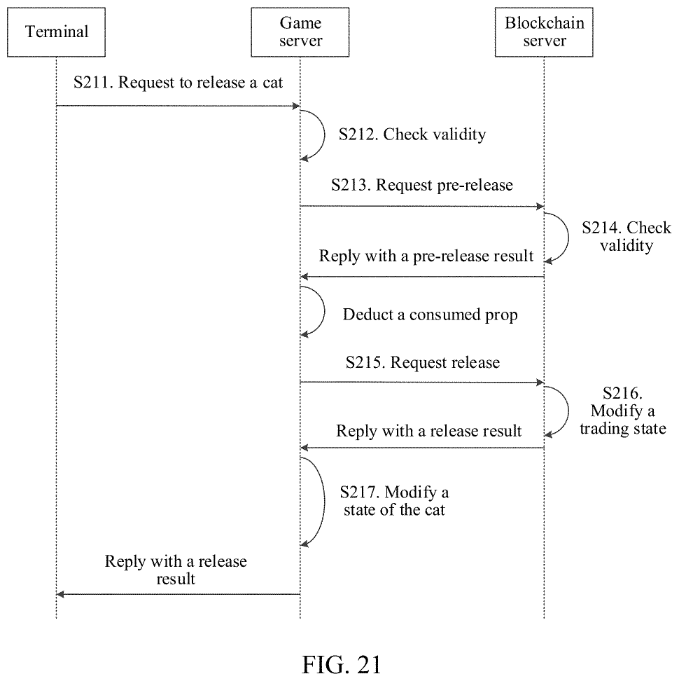

FIG. 21 is a schematic flowchart of releasing a virtual cat involved in an embodiment of this disclosure. As shown in FIG. 21, the release process may be as follows:

S211. A player taps release in a virtual cat backpack of the player, and inputs a selling price, and a terminal transmits a release request to a game server.

S212. The game server checks validity of this release trading, including validity of ownership of the virtual cat, price validity, salable state validity, whether props are sufficient, whether a mailbox is full, and the like.

S213. After checking release validity, the game server requests pre-release from a blockchain server.

S214. The blockchain server re-checks validity of the release, and returns a pre-release result to the game server if the release is valid.

S215. After receiving a correct pre-release result, the game server deducts a release consumption prop from the player's account, and then requests release to the blockchain server.

S216. The blockchain server processes the release request, adds this purchase order to a publicity area of a market, modifies a trading state of the cat in the blockchain, and finally replies to the game server with a release result.

Optionally, before processing the release request, the blockchain server re-checks the release validity, and further checks whether the release consumption prop is successfully deducted from the user's account in addition to validity such as the validity of ownership of the virtual cat, the price validity, the salable state validity, whether props are sufficient, and whether a mailbox is full in the current detection.

S217. After receiving a release success result, the game server modifies the state of the cat, instructs a client to refresh the latest state of the cat, and finally replies to the player with the release result.

To sum up, in the solution shown in this embodiment of this disclosure, after receiving a pet commodity release request transmitted by the terminal, the server cluster obtains the verification information with extremely high stability and reliability from the blockchain system to verify validity of the request, and trades a pet commodity after the verification is valid, thereby greatly improving security of trading a virtual pet.

Furthermore, in one implementation, after the price of a pet commodity is reduced, the server cluster only allows the pet commodity to be traded after publicizing the pet commodity in the publicity area for a certain period, and moreover, only publicity within a predetermined time period is regarded as a valid publicity time, thereby effectively avoiding point-to-point trading, and further improving security of trading a virtual pet.

After the foregoing user releases a pet commodity, the pet commodity may be further suspended (or unlisted) before the pet commodity is sold, to cancel sale of the pet commodity, and the suspension process also needs to be verified.

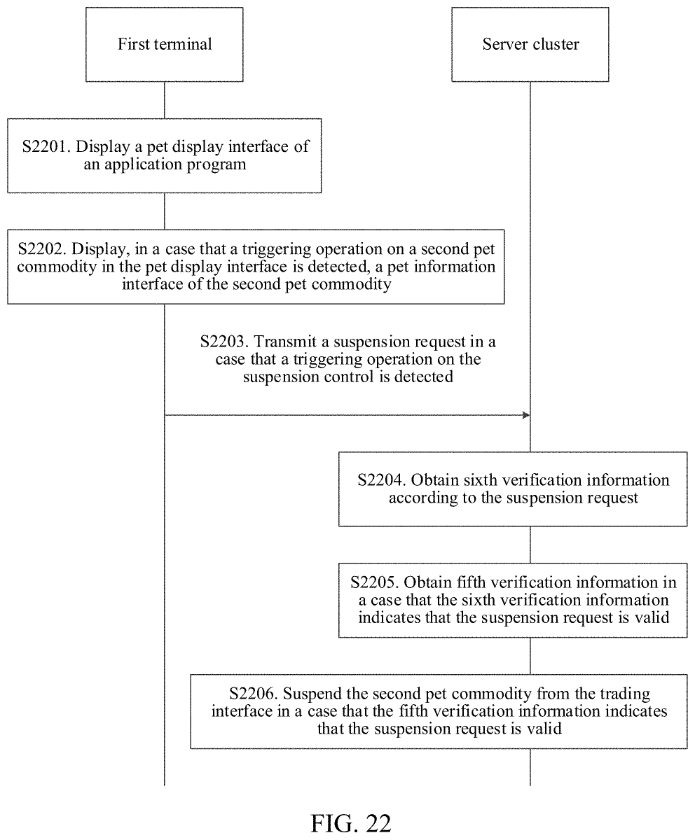

FIG. 22 is a method flowchart of a method for trading a virtual pet commodity according to an exemplary embodiment of this disclosure. The method may be performed by the terminal 120 and the server cluster 140 in the system shown in FIG. 1, where an application program is installed in the terminal, the server cluster is configured to provide backend support for the application program, the application program is provided with a virtual pet, and at least one pet image of the virtual pet is generated based on a genetic inheritance rule. As shown in FIG. 22, the method may include the following several steps:

Step S2201. A third terminal displays a pet display interface of the application program, the pet display interface being used for displaying a pet commodity owned by a second account, and the second account being an account logging in to the terminal.

The step is similar to step S1601, and details are not described herein again.

Step S2202. The third terminal displays, when a triggering operation on a second pet commodity in the pet display interface is detected, a pet information interface of the second pet commodity.

The second pet commodity is a virtual pet having been released in the trading interface, the pet information interface includes a suspension control of the second pet commodity, and the second pet commodity is a second virtual pet or a virtual prop used for obtaining the second virtual pet.

Step S2203. The third terminal transmits a suspension request to a server cluster when a triggering operation on the suspension control is detected, and the server cluster receives the suspension request.

For example, the foregoing pet information interface may be similar to the foregoing interface shown in FIG. 6, and correspondingly, a user may also view, from the trading interface, a pet commodity being sold by the user, and turn on the pet information interface of the pet commodity through the trading interface. When the user triggers the suspension control in the pet information interface, the third terminal transmits the suspension request to the server cluster.

Step S2204. The server cluster obtains sixth verification information according to the suspension request, the sixth verification information being third type information that is stored out of the blockchain system and that is used for indicating validity of the suspension request.

The third type information includes at least one of the following information:

1. Whether the ownership of the second pet commodity is valid.

The information indicates whether the second pet commodity is owned by the third account selling the second pet commodity. If the second pet commodity is owned by the third account, the suspension request is valid; otherwise, the suspension request is invalid.

2. Whether a suspendable state of the second pet commodity is valid.

The information indicates whether the second pet commodity is in the suspendable state. When the second pet commodity is in the suspendable state, the suspension request is valid; otherwise, the suspension request is invalid.

Step S2205. The server cluster obtains, when the sixth verification information indicates that the suspension request is valid, fifth verification information according to the suspension request, the fifth verification information being third type information that is stored in a blockchain system and that is used for indicating validity of the suspension request.

Similarly, in this embodiment of this disclosure, if validity is always determined through the third type information stored in the blockchain system, an excessively large pressure on the blockchain system is caused in a case of very frequent suspension requests. To avoid causing an unnecessary pressure on the blockchain system, and further improve verification accuracy, in this embodiment of this disclosure, before obtaining the fifth verification information stored in the blockchain system, the server cluster may first obtain the sixth verification information stored out of the blockchain system. When the sixth verification information indicates that the suspension request is invalid, the suspension request may be rejected. Only when the sixth verification information indicates that the suspension request is valid, the subsequent step of obtaining the fifth verification information is performed.

Step S2206. Suspend the second pet commodity from the trading interface when the fifth verification information indicates that the suspension request is valid.

When determining, through information in the blockchain system, that the suspension request is valid, the server cluster may remove the second pet commodity from the trading interface, and notify the third terminal.

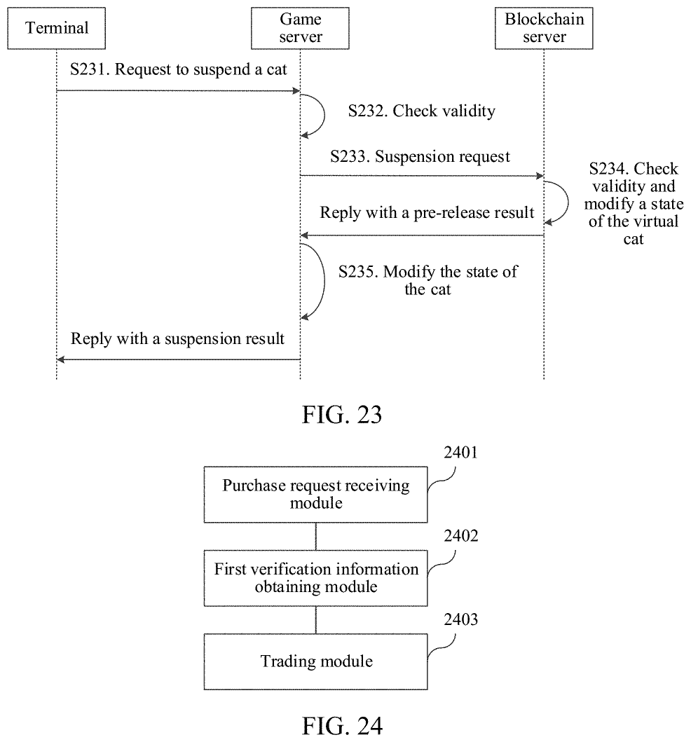

For example, FIG. 23 is a schematic flowchart of suspending a virtual cat involved in an embodiment of this disclosure. As shown in FIG. 23, the suspension process may be as follows:

S231. After a player taps suspension in a virtual cat backpack of the player, a terminal transmits a suspension request to a game server, the virtual cat backpack being associated with a virtual cat

S232. The game server checks validity of this suspension operation, including validity of ownership of the virtual cat and state validity.

S233. After checking to find that suspension is valid, the game server transmits the suspension request to a blockchain server.

S234. The blockchain server checks validity of suspension, deletes, after determining that the suspension is valid, this virtual cat from the trading market, modifies the state of the virtual cat in the blockchain, and finally replies with a suspension result.

S235. After receiving a suspension success result, the game server modifies the state of the virtual cat, instructs a client running on the terminal to refresh the latest state of the virtual cat, and finally replies to the player with the suspension result.

To sum up, in the solution shown in this embodiment of this disclosure, after receiving a pet commodity suspension request transmitted by the terminal, the server cluster obtains the verification information with extremely high stability and reliability from the blockchain system to verify validity of the request, and trades a pet commodity after the verification is valid, thereby greatly improving security of trading a virtual pet.

In the solutions shown in the foregoing embodiments of this application, the idea is considered based on security, transparency, and fairness of trading, and the blockchain technology is introduced as the technical bottom layer, to ensure security. Through the system design (publicity area+curfew mechanism), the threshold for the generation of economic circulation risks and the crackdown on black market has been greatly raised, and the insecurity and related risks of transactions in traditional games have been solved. At the same time, this embodiment provides a solution for the display and sale of ultra-diversified products.

FIG. 24 shows an apparatus for trading a virtual pet commodity according to an exemplary embodiment of this disclosure. The apparatus for trading a virtual pet commodity may be applied to a server cluster providing backend support for an application program, to perform all or some steps performed by the server cluster in the foregoing method embodiments, the application program is provided with a three-dimensional virtual pet, and at least one pet image of the three-dimensional virtual pet is generated based on a genetic inheritance rule. The apparatus for trading a virtual pet commodity may include:

a purchase request receiving module 2401, configured to receive a purchase request transmitted by a first terminal, the purchase request being used for requesting to purchase a first pet commodity, and the first pet commodity being a first virtual pet or a virtual prop used for obtaining the first virtual pet;

a first verification information obtaining module 2402, configured to obtain first verification information according to the purchase request, the first verification information being first type information that is stored in a blockchain system and that is used for indicating validity of the purchase request; and

a trading module 2403, configured to transfer ownership of the first pet commodity from a second account to a first account when the first verification information indicates that the purchase request is valid, the first account being an account logging in to the first terminal and initiating the purchase request, and the second account being an account selling the first pet commodity.

Optionally, the apparatus further includes:

a second verification information obtaining module, configured to obtain, before the first verification information obtaining module obtains the first verification information according to the purchase request, second verification information according to the purchase request, the second verification information being first type information that is stored out of the blockchain system and that is used for indicating the validity of the purchase request; and

the first verification information obtaining module 2402 is specifically configured to perform, when the second verification information indicates that the purchase request is valid, the operation of obtaining first verification information according to the purchase request.

Optionally, the apparatus further includes:

a locking module, configured to set a lock state of the first pet commodity to a locked state before the trading module completes the transferring ownership of the first pet commodity from a second account to a first account.

Optionally, the first type information includes:

at least one of whether the ownership of the first pet commodity is valid, whether a price of the first pet commodity is valid, whether a salable state of the first pet commodity is valid, whether the lock state of the first pet commodity is an unlocked state, whether the first account owns resources required for purchasing the first pet commodity, and whether the resources required for purchasing the first pet commodity are successfully deducted.

Optionally, the apparatus further includes:

a release request receiving module, configured to receive a release request transmitted by a second terminal, the release request being used for requesting to release and sell the first pet commodity;

a third verification information obtaining module, configured to obtain third verification information according to the release request, the third verification information being second type information that is stored in the blockchain system and that is used for indicating validity of the release request; and

a release module, configured to release the first pet commodity in a trading interface when the third verification information indicates that the release request is valid.

Optionally, the apparatus further includes:

a fourth verification information obtaining module, configured to obtain, before the third verification information obtaining module obtains the third verification information according to the release request, fourth verification information according to the release request, the fourth verification information being second type information that is stored out of the blockchain system and that is used for indicating the validity of the release request; and

the third verification information obtaining module is specifically configured to perform, when the fourth verification information indicates that the release request is valid, the operation of obtaining third verification information according to the release request.

Optionally, the release module is specifically configured to:

add, when the third verification information indicates that the release request is valid, an information display control of the first pet commodity to a publicity area in the trading interface, where each virtual pet in the publicity area is in a trading prohibited state, and the information display control is used for displaying information about the corresponding virtual pet; and

add a purchase entrance of the first pet commodity to a trading area in the trading interface when a valid display duration of the information display control of the first pet commodity in the publicity area reaches a preset duration.

Optionally, the valid display duration is a display duration in a designated time period in each predetermined cycle.

Optionally, the second type information includes:

at least one of whether the ownership of the first pet commodity is valid, whether a price of the first pet commodity is valid, whether a salable state of the first pet commodity is valid, whether the second account owns resources required for releasing the first pet commodity, whether a mailbox of the second account is full, and whether the resources required for releasing the first pet commodity are successfully deducted.

Optionally, the apparatus further includes:

a suspension request receiving module, configured to receive a suspension request transmitted by a third terminal, the suspension request being used for requesting to suspend a second pet commodity from a trading interface of the application program, and the second pet commodity being a second virtual pet or a virtual prop used for obtaining the second virtual pet;

a fifth verification information obtaining module, configured to obtain fifth verification information according to the suspension request, the fifth verification information being third type information that is stored in the blockchain system and that is used for indicating validity of the suspension request; and

a suspension module, configured to suspend the second pet commodity from the trading interface when the fifth verification information indicates that the suspension request is valid.

Optionally, the apparatus further includes:

a sixth verification information obtaining module, configured to obtain, before the fifth verification information obtaining module obtains the fifth verification information according to the suspension request, sixth verification information according to the suspension request, the sixth verification information being third type information that is stored out of the blockchain system and that is used for indicating the validity of the suspension request; and

the sixth verification information obtaining module is specifically configured to perform, when the sixth verification information indicates that the suspension request is valid, the operation of obtaining fifth verification information according to the suspension request.

Optionally, the third type information includes:

at least one of whether ownership of the second pet commodity is valid and whether a suspendable state of the second pet commodity is valid.

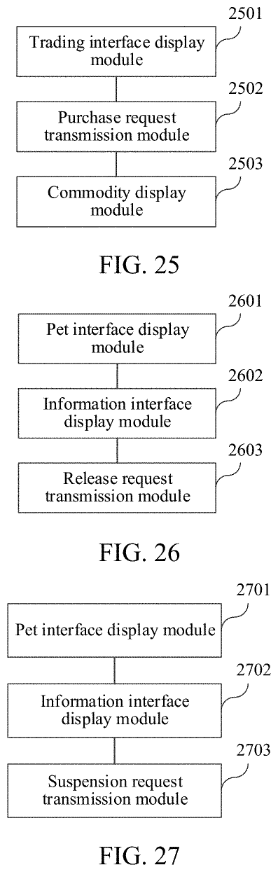

FIG. 25 shows an apparatus for trading a virtual pet commodity according to an exemplary embodiment of this disclosure. The apparatus for trading a virtual pet commodity may be applied to a terminal on which an application program is run, to perform all or some steps performed by the first terminal in the foregoing method embodiments, the application program is provided with a three-dimensional virtual pet, and at least one pet image of the three-dimensional virtual pet is generated based on a genetic inheritance rule. The apparatus for trading a virtual pet commodity may include:

a trading interface display module 2501, configured to display a trading interface of the application program, the trading interface including a purchase control of a first pet commodity, and the first pet commodity being a first virtual pet or a virtual prop used for obtaining the first virtual pet;

a purchase request transmission module 2502, configured to transmit a purchase request to a server cluster when a triggering operation on the purchase control is detected, the purchase request being used for triggering the server cluster to obtain first verification information; and transfer ownership of the first pet commodity from a second account to a first account when the first verification information indicates that the purchase request is valid, the first verification information being first type information that is stored in a blockchain system and is used for indicating validity of the purchase request, the first account being an account logging in to the terminal and initiating the purchase request, and the second account being an account selling the first pet commodity; and

a commodity display module 2503, configured to display the first pet commodity in a pet display interface of the application program, the pet display interface being used for displaying a virtual pet owned by the first account.

Optionally, the apparatus further includes:

a price trend control display module, configured to display a price trend control of the first pet commodity in the trading interface; and

a price trend interface display module, configured to display a price trend interface of the first pet commodity when a triggering operation on the price trend control is detected, where the price trend interface displays a price of the first pet commodity at each time point after the first pet commodity is released.

FIG. 26 shows an apparatus for trading a virtual pet commodity according to an exemplary embodiment of this disclosure. The apparatus for trading a virtual pet commodity may be applied to a terminal on which an application program is run, to perform all or some steps performed by the second terminal in the foregoing method embodiments, the application program is provided with a three-dimensional virtual pet, and at least one pet image of the three-dimensional virtual pet is generated based on a genetic inheritance rule. The apparatus for trading a virtual pet commodity may include:

a pet interface display module 2601, configured to display a pet display interface of the application program, the pet display interface being used for displaying a pet commodity owned by a second account, and the second account being an account logging in to the terminal;

an information interface display module 2602, configured to display, when a triggering operation on a first pet commodity in the pet display interface is detected, a pet information interface of the first pet commodity, the pet information interface of the first pet commodity including a sale control of the first pet commodity, and the first pet commodity being a first virtual pet or a virtual prop used for obtaining the first virtual pet; and

a release request transmission module 2603, configured to transmit a release request to a server cluster when a triggering operation on the sale control is detected, the release request being used for triggering the server cluster to obtain third verification information; and release the first pet commodity in a trading interface of the application program when the third verification information indicates that the release request is valid, the third verification information being release verification information that is stored in a blockchain system and that is used for indicating validity of the release request.

FIG. 27 shows an apparatus for trading a virtual pet commodity according to an exemplary embodiment of this disclosure. The apparatus for trading a virtual pet commodity may be applied to a terminal on which an application program is run, to perform all or some steps performed by the third terminal in the foregoing method embodiments, the application program is provided with a three-dimensional virtual pet, and at least one pet image of the three-dimensional virtual pet is generated based on a genetic inheritance rule. The apparatus for trading a virtual pet commodity may include:

a pet interface display module 2701, configured to display a pet display interface of the application program, the pet display interface being used for displaying a pet commodity owned by a third account, and the third account being an account logging in to the terminal;

an information interface display module 2702, configured to display, when a triggering operation on a second pet commodity in the pet display interface is detected, a pet information interface of the second pet commodity, the second pet commodity being a virtual pet having been released in the trading interface, the pet information interface including a suspension control of the second pet commodity, and the second pet commodity being a second virtual pet or a virtual prop used for obtaining the second virtual pet; and

a suspension request transmission module 2703, configured to transmit a suspension request to a server cluster when a triggering operation on the suspension control is detected, the suspension request being used for triggering the server cluster to obtain fifth verification information; and suspend the second pet commodity from the trading interface when the fifth verification information indicates that the suspension request is valid, the fifth verification information being suspension verification information that is stored in a blockchain system and that is used for indicating validity of the suspension request.

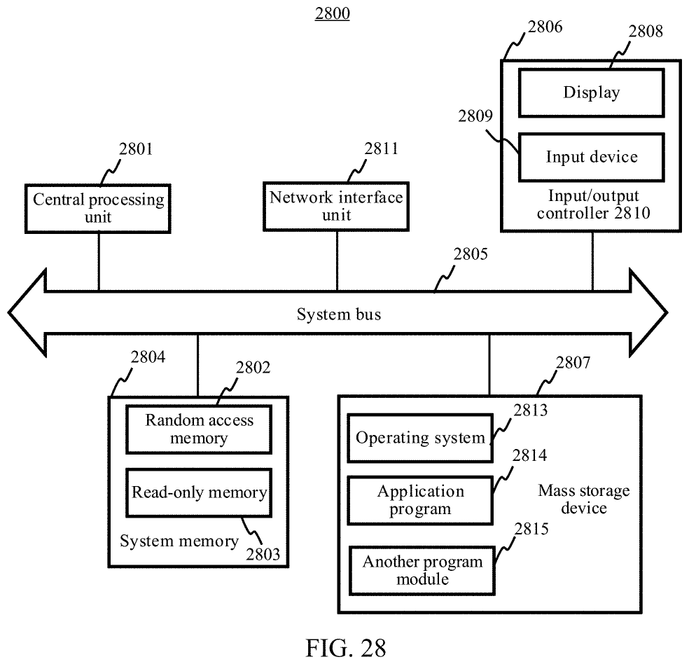

FIG. 28 is a structural block diagram of a computer device according to an exemplary embodiment of this disclosure. The computer device may be implemented as a server cluster. The computer device 2800 includes a central processing unit (CPU) 2801, a system memory 2802 including a random access memory (RAM) 2803 and a read-only memory (ROM) 2804, and a system bus 2805 connecting the system memory 2804 to the CPU 2801. The computer device 2800 further includes a basic input/output system (I/O system) 2806 used for helping information transmission between components in a computer, and a mass storage device 2807 used for storing an operating system 2813, an application program 2814, and another program module 2815.

The basic I/O system 2806 includes a display 2808 configured to display information and an input device 2809, such as a mouse or a keyboard, configured to input information for a user. The display 2808 and the input device 2809 are both connected to the CPU 2801 by using an input/output controller 2810 connected to the system bus 2805. The basic I/O system 2806 may further include the input/output controller 2810 to be configured to receive and process inputs from multiple other devices such as a keyboard, a mouse, and an electronic stylus. Similarly, the input/output controller 2810 further provides an output to a display screen, a printer, or another type of output device.

The mass storage device 2807 is connected to the CPU 2801 by using a mass storage controller (not shown) connected to the system bus 2805. The mass storage device 2807 and its associated computer readable medium provide non-volatile storage for the computer device 2800. That is, the mass storage device 2807 may include the computer readable medium (not shown) such as a hard disk or a CD-ROM driver.

Without loss of generality, the computer readable medium may include a computer storage medium and a communication medium. The computer storage medium includes volatile and non-volatile media, and removable and non-removable media implemented by using any method or technology and configured to store information such as a computer-readable instruction, a data structure, a program module, or other data. The computer storage medium includes a RAM, a ROM, an EPROM, an EEPROM, a flash memory, or other solid storage technologies; a CD-ROM, a DVD, or other optical storages; and a cassette, a magnetic tape, a disk storage, or other magnetic storage devices. Certainly, persons skilled in art can know that the computer storage medium is not limited to the foregoing several types. The system memory 2804 and the mass storage device 2807 may be collectively referred to as a memory.

The computer device 2800 may be connected to the Internet or another network device through a network interface unit 2811 connected to the system bus 2805.

The memory further includes one or more programs, the one or more programs are stored in the memory, and the CPU 2801 implements, by executing the one or more programs, all or some steps performed by the server cluster in the method for trading a virtual pet commodity shown in the foregoing embodiments.

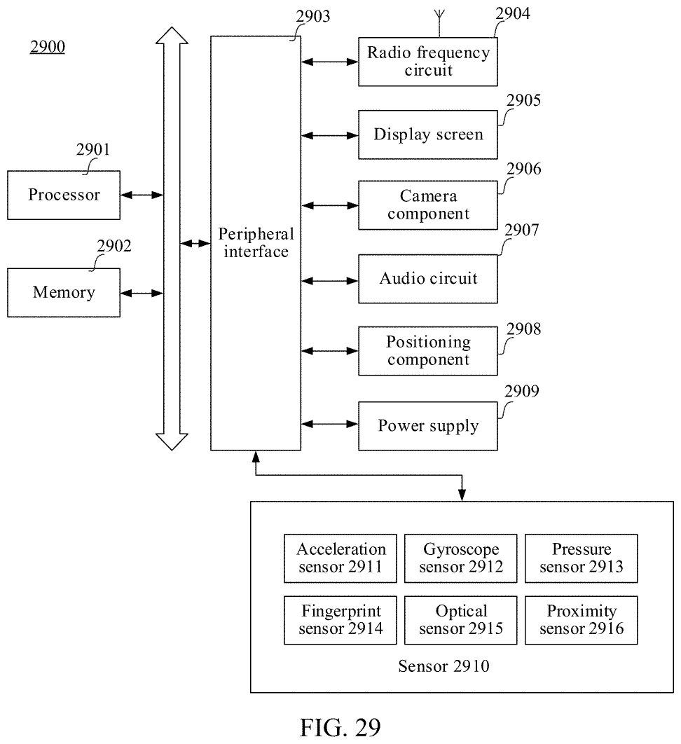

FIG. 29 is a structural block diagram of a computer device 2900 according to an exemplary embodiment of this disclosure. The computer device 2900 may be a terminal such as a smartphone, a tablet computer, a Moving Picture Experts Group Audio Layer III (MP3) player, a Moving Picture Experts Group Audio Layer IV (MP4) player, a notebook computer or a desktop computer. The computer device 2900 may be further referred to as user equipment, a portable terminal, a laptop terminal, a desktop terminal or another name.

Usually, the computer device 2900 includes: a processor 2901 and a memory 2902.

The processor 2901 may include one or more processing cores, for example, a 4-core processor or an 8-core processor. The processor 2901 may be implemented in at least one hardware form of a digital signal processor (DSP), a field-programmable gate array (FPGA), and a programmable logic array (PLA). The processor 2901 may alternatively include a main processor and a coprocessor. The main processor is configured to process data in an awake state, also referred to as a central processing unit (CPU); and the coprocessor is a low-power processor configured to process data in a standby state. In some embodiments, the processor 2901 may be integrated with a graphics processing unit (GPU). The GPU is configured to be responsible for rendering and drawing content that a display screen needs to display. In some embodiments, the processor 2901 may further include an artificial intelligence (AI) processor. The AI processor is configured to process a computing operation related to machine learning.

The memory 2902 may include one or more computer-readable storage media. The computer-readable storage medium may be non-transitory. The memory 2902 may further include a high-speed random access memory and a non-transitory memory such as one or more magnetic disk storage devices and a flash storage device. In some embodiments, the non-transitory computer-readable storage medium in the memory 2902 is configured to store at least one instruction, and the at least one instruction being configured to be executed by the processor 2901 to implement steps performed by the first terminal, the second terminal or the third terminal in the method for trading a virtual pet commodity provided in the method embodiments of this application.

In some embodiments, the computer device 2900 further optionally includes a peripheral interface 2903 and at least one peripheral. The processor 2901, the memory 2902, and the peripheral interface 2903 may be connected through a bus or a signal cable. Each peripheral may be connected to the peripheral interface 2903 through a bus, a signal cable, or a circuit board. Specifically, the peripheral includes: at least one of a radio frequency (RF) circuit 2904, a touch display screen 2905, a camera component 2906, an audio circuit 2907, a positioning component 2908, and a power supply 2909.

The peripheral interface 2903 may be configured to connect at least one peripheral related to input/output (I/O) to the processor 2901 and the memory 2902. In some embodiments, the processor 2901, the memory 2902, and the peripheral interface 2903 are integrated into a same chip or circuit board; and in some other embodiments, any one or two of the processor 2901, the memory 2902, and the peripheral interface 2903 may be implemented on an independent chip or circuit board. This is not limited in this embodiment.

The RF circuit 2904 is configured to receive and transmit an RF signal, which is also referred to as an electromagnetic signal. The radio frequency circuit 2904 communicates with a communication network and another communication device by using the electromagnetic signal. The RF circuit 2904 converts an electric signal into an electromagnetic signal for transmission, or converts a received electromagnetic signal into an electric signal. Optionally, the RF circuit 2904 includes: an antenna system, an RF transceiver, one or more amplifiers, a tuner, an oscillator, a digital signal processor, a codec chip set, a subscriber identity module card, and the like. The RF circuit 2904 may communicate with other terminals through at least one wireless communication protocol. The wireless communication protocol includes, but is not limited to: World Wide Web, a metropolitan area network, an intranet, various generations of mobile communication networks (2G, 3G, 4G, and 5G), a wireless local area network and/or a wireless fidelity (Wi-Fi) network. In some embodiments, the RF circuit 2904 may also include a circuit related to near field communication (NFC). This is not limited in this application.

The display 2905 is configured to display a user interface (UI). The UI may include a graph, a text, an icon, a video, and any combination thereof. When the display 2905 is a touch display, the display 2905 is further capable of acquiring a touch signal on or above a surface of the display 2905. The touch signal may be inputted to the processor 2901 for processing as a control signal. In this case, the display screen 2905 may be further configured to provide a virtual button and/or a virtual keyboard, which is also referred to as a soft button and/or a soft keyboard. In some embodiments, there may be one display screen 2905, disposed on a front panel of the computer device 2900. In other some embodiments, there may be at least two display screens 2905, disposed on different surfaces of the computer device 2900 respectively or in a folded design. In still other embodiments, the display screen 2905 may be a flexible display screen, disposed on a curved surface or a folded surface of the computer device 2900. Even, the display screen 2905 may be further set in a non-rectangular irregular pattern, namely, a special-shaped screen. The display screen 2905 may be prepared by using a material such as a liquid crystal display (LCD), an organic light-emitting diode (OLED), or the like.

The camera component 2906 is configured to acquire an image or a video. Optionally, the camera component 2906 includes a front-facing camera and a rear-facing camera. Generally, the front-facing camera is disposed on the front panel of the terminal, and the rear-facing camera is disposed on a back face of the terminal. In some embodiments, there are at least two rear-facing cameras, which are respectively any one of a main camera, a depth of field camera, a wide-angle camera, and a telephoto camera, to implement a background blurring function by fusing the main camera and the depth of field camera, and panoramic shooting and virtual reality (VR) shooting functions or other fusing shooting functions by fusing the main camera and the wide-angle camera. In some embodiments, the camera component 2906 may further include a flash. The flash may be a single color temperature flash, or may be a double color temperature flash. The double color temperature flash is a combination of a warm light flash and a cold light flash, and may be used for light compensation under different color temperatures.

The audio circuit 2907 may include a microphone and a speaker. The microphone is configured to: acquire sound waves of a user and an environment, and convert the sound waves into electrical signals and input the electrical signals into the processor 2901 for processing, or input the electrical signals into the RF circuit 2904 to implement speech communication. For the purpose of stereo collection or noise reduction, there may be a plurality of microphones, disposed at different parts of the computer device 2900 respectively. The microphone may be further an array microphone or an omnidirectional collection microphone. The speaker is configured to convert electrical signals from the processor 2901 or the RF circuit 2904 into sound waves. The speaker may be a conventional thin-film speaker, or may be a piezoelectric ceramic speaker. When the speaker is the piezoelectric ceramic speaker, electrical signals not only can be converted into sound waves that can be heard by human, but also can be converted into sound waves that cannot be heard by human for ranging and other uses. In some embodiments, the audio circuit 2907 may also include an earphone jack.

The positioning component 2908 is configured to determine a current geographic location of the computer device 2900, to implement navigation or a location based service (LBS). The positioning component 2908 may be a positioning component based on the Global Positioning System (GPS) of the United States, the BeiDou system of China, the Global Navigation Satellite System (GLONASS) of Russia, or the GALILEO System of the European.

The power supply 2909 is configured to supply power for various components in the computer device 2900. The power supply 2909 may be an alternating current, a direct current, a disposable battery, or a rechargeable battery. When the power supply 2909 includes a rechargeable battery, the rechargeable battery may be a wired rechargeable battery or a wireless rechargeable battery. The wired rechargeable battery is a battery that is charged by a wired line, and the wireless rechargeable battery is a battery that is charged by a wireless coil. The rechargeable battery may further be configured to support a quick charge technology.

In some embodiments, the computer device 2900 may also include one or more sensors 2910. The one or more sensors 2910 include, but are not limited to: an acceleration sensor 2911, a gyroscope sensor 2912, a pressure sensor 2913, a fingerprint sensor 2914, an optical sensor 2915, and a proximity sensor 2916.

The acceleration sensor 2911 may detect accelerations on three coordinate axes of a coordinate system established by the computer device 2900. For example, the acceleration sensor 2911 may be configured to detect components of the gravity acceleration on the three coordinate axes. The processor 2901 may control, according to a gravity acceleration signal collected by the acceleration sensor 2911, the touch display screen 2905 to display the user interface in a frame view or a portrait view. The acceleration sensor 2911 may be further configured to collect game or user motion data.

The gyroscope sensor 2912 may detect a body direction and a rotation angle of the computer device 2900. The gyroscope sensor 2912 may collect a 3D action of the user on the computer device 2900 together with the acceleration sensor 2911. The processor 2901 may implement the following functions according to the data collected by the gyroscope sensor 2912: motion sensing (such as changing the UI according to a tilt operation of the user), image stabilization during shooting, game control, and inertial navigation.

The pressure sensor 2913 may be disposed on a side frame of the computer device 2900 and/or a lower layer of the touch display screen 2905. When the pressure sensor 2913 is disposed on the side frame of the computer device 2900, a holding signal of the user to the computer device 2900 may be detected, and left/right hand identification or a quick action may be performed by the processor 2901 according to the holding signal collected by the pressure sensor 2913. When the pressure sensor 2913 is disposed on the lower layer of the touch display 2905, the processor 2901 controls an operable control on the UI interface according to a pressure operation of the user on the touch display 2905. The operable control includes at least one of a button control, a scroll bar control, an icon control and a menu control.

The fingerprint sensor 2914 is configured to collect a user's fingerprint, and the processor 2901 identifies a user's identity according to the fingerprint collected by the fingerprint sensor 2914, or the fingerprint sensor 2914 identifies a user's identity according to the collected fingerprint. When the identity of the user is identified as a trusted identity, the processor 2901 authorizes the user to perform a related sensitive operation. The sensitive operation includes unlocking a screen, viewing encryption information, downloading software, payment, changing settings, and the like. The fingerprint sensor 2914 may be disposed on a front face, a back face, or a side face of the computer device 2900. When a physical button or a vendor logo is disposed on the computer device 2900, the fingerprint sensor 2914 may be integrated together with the physical button or the vendor logo.

The optical sensor 2915 is configured to collect ambient light intensity. In an embodiment, the processor 2901 may control the display brightness of the touch display screen 2905 according to the ambient light intensity collected by the optical sensor 2915. Specifically, when the ambient light intensity is relatively high, the display brightness of the touch display screen 2905 is turned up. When the ambient light intensity is relatively low, the display brightness of the touch display screen 2905 is turned down. In another embodiment, the processor 2901 may further dynamically adjust a camera parameter of the camera component 2915 according to the ambient light intensity collected by the optical sensor 2906.

The proximity sensor 2916, also referred to as a distance sensor, is usually disposed on a front panel of the computer device 2900. The proximity sensor 2916 is configured to collect a distance between a user and the front surface of the computer device 2900. In an embodiment, when the proximity sensor 2916 detects that the distance between the user and the front surface of the computer device 2900 gradually decreases, the touch display 2901 is controlled by the processor 2905 to switch from a screen-on state to a screen-off state. When the proximity sensor 2916 detects that the distance between the user and the front surface of the computer device 2900 gradually increases, the touch display 2901 is controlled by the processor 2905 to switch from the screen-off state to the screen-on state.

A person skilled in the art may understand that the structure shown in FIG. 29 does not constitute a limitation on the computer device 2900, and the terminal may include more or fewer components than those shown in the figure, or some components may be combined, or a different component deployment may be used.

An exemplary embodiment further provides a non-transitory computer-readable storage medium including an instruction, for example, a memory including at least one instruction, at least one program, a code set, or an instruction set, and the at least one instruction, the at least one the program, the code set, or the instruction set may be executed by a processor to complete all or some steps performed by the server cluster, the first terminal, the second terminal or the third terminal in the foregoing methods for trading a virtual pet commodity. For example, the non-transitory computer readable storage medium may be a ROM, a random access memory (RAM), a CD-ROM, a magnetic tape, a floppy disk, an optical data storage device, or the like.

After considering the specification and practicing the present disclosure, a person skilled in the art would easily conceive of other implementations of this application. This application is intended to cover any variation, use, or adaptive change of this application. The variations, uses, or adaptive changes follow the general principles of this application and include common general knowledge or common technical means in the art that are not disclosed in this application. The specification and the embodiments are considered as merely exemplary, and the real scope and spirit of this application are pointed out in the following claims.

It is to be understood that this application is not limited to the precise structures described above and shown in the accompanying drawings, and various modifications and changes can be made without departing from the scope of this application. The scope of this application is limited only by the appended claims.

What is claimed is:

1. A method for trading a virtual pet commodity, performed by a server providing backend support for an application program, the application program being provided with virtual pets, and at least one pet image of each of the virtual pets being generated based on a genetic inheritance rule, the method comprising:
receiving a purchase request transmitted by a first terminal, the purchase request being used for requesting to purchase a first pet commodity, and the first pet commodity comprising a first virtual pet or a virtual prop used for obtaining the first virtual pet;
obtaining first verification information according to the purchase request, the first verification information being first type information stored in a blockchain system and used for indicating validity of the purchase request; and
transferring ownership of the first pet commodity from a second account to a first account when the first verification information indicates that the purchase request is valid, the first account being an account used for logging in to the first terminal to initiate the purchase request, and the second account being an account selling the first pet commodity.

2. The method according to claim 1, wherein before obtaining the first verification information according to the purchase request, the method further comprises:
obtaining second verification information according to the purchase request, the second verification information being first type information stored out of the blockchain system and used for indicating the validity of the purchase request; and
wherein obtaining the first verification information according to the purchase request comprises:
when the second verification information indicates that the purchase request is valid, obtaining the first verification information according to the purchase request.

3. The method according to claim 1, further comprising:
setting, when the first verification information indicates that the purchase request is valid, a lock state of the first pet commodity to a locked state before completing transferring the ownership of the first pet commodity from a second account to a first account.

4. The method according to claim 1, wherein the first type information comprises at least one of:
validity of an ownership of the first pet commodity;
validity of a price of the first pet commodity;
validity of a salable state of the first pet commodity;
lock state of the first pet commodity;
whether the first account owns resources required for purchasing the first pet commodity; or
whether the resources required for purchasing the first pet commodity are successfully deducted.

5. The method according to claim 1, further comprising:
receiving a release request transmitted by a second terminal, the release request being used for requesting to release and sell the first pet commodity;
obtaining third verification information according to the release request, the third verification information being second type information stored in the blockchain system and used for indicating validity of the release request; and
releasing the first pet commodity in a trading interface when the third verification information indicates that the release request is valid.

6. The method according to claim 5, wherein:
before obtaining the third verification information according to the release request, the method further comprises:
obtaining fourth verification information according to the release request, the fourth verification information being second type information stored out of the blockchain system and used for indicating validity of the release request; and
obtaining the third verification information according to the release request comprises:
when the fourth verification information indicates that the release request is valid, obtaining the third verification information according to the release request.

7. The method according to claim 5, wherein releasing the first pet commodity in a trading interface when the third verification information indicates that the release request is valid comprises:
adding, when the third verification information indicates that the release request is valid, an information display control of the first pet commodity to a publicity area in the trading interface, wherein each virtual pet in the publicity area is in a trading prohibited state, and the information display control is used for displaying information about the corresponding virtual pet; and
adding a purchase entry of the first pet commodity to a trading area in the trading interface when a valid display duration of the information display control of the first pet commodity in the publicity area reaches a preset duration.

8. The method according to claim 7, wherein the valid display duration is a display duration in a designated time period in each predetermined cycle.

9. The method according to claim 5, wherein the second type information comprises at least one of:
validity of an ownership of the first pet commodity;
validity of a price of the first pet commodity;
validity of a salable state of the first pet commodity;
lock state of the first pet commodity;
whether the second account owns resources required for releasing the first pet commodity;
whether a mailbox of the second account is full; or
whether the resources required for releasing the first pet commodity are successfully deducted.

10. The method according to claim 1, further comprising:
receiving a suspension request transmitted by a third terminal, the suspension request being used for requesting to suspend a second pet commodity from a trading interface of the application program, and the second pet commodity being a second virtual pet or a virtual prop used for obtaining the second virtual pet;
obtaining fifth verification information according to the suspension request, the fifth verification information being third type information stored in the blockchain system and used for indicating validity of the suspension request; and
suspending the second pet commodity from the trading interface when the fifth verification information indicates that the suspension request is valid.

11. The method according to claim 10, wherein before obtaining the fifth verification information according to the suspension request, the method further comprises:
obtaining sixth verification information according to the suspension request, the sixth verification information being the third type information stored out of the blockchain system and used for indicating validity of the suspension request; and
wherein obtaining the sixth verification information according to the suspension request comprises:
obtaining, when the sixth verification information indicates that the suspension request is valid, fifth verification information according to the suspension request.

12. The method according to claim 10, wherein the third type information comprises at least one of:
validity of ownership of the second pet commodity; or
suspendable state of the second pet commodity.

13. A method for trading a virtual pet commodity, performed by a terminal on which an application program is run, the application program being provided with virtual pets, and at least one pet image of each of the virtual pets being generated based on a genetic inheritance rule, the method comprising:
displaying a trading interface of the application program, the trading interface comprising a purchase control of a first pet commodity, and the first pet commodity being a first virtual pet or a virtual prop used for obtaining the first virtual pet;
transmitting a purchase request to a server when a triggering operation on the purchase control is detected, the purchase request being used for triggering the server to obtain first verification information, and transferring ownership of the first pet commodity from a second account to a first account when the first verification information indicates that the purchase request is valid, the first verification information being first type information stored in a blockchain system and used for indicating validity of the purchase request, the first account being an account used for logging in to the terminal to initiate the purchase request, and the second account being an account selling the first pet commodity; and
displaying the first pet commodity in a pet display interface of the application program, the pet display interface being used for displaying a virtual pet owned by the first account.

14. The method according to claim 13, further comprising:
displaying a price trend control of the first pet commodity in the trading interface; and
displaying a price trend interface of the first pet commodity when a triggering operation on the price trend control is detected, wherein the price trend interface comprises a price of the first pet commodity at each time point after the first pet commodity is released.

15. A method according to claim 13, further comprising:
displaying the pet display interface of the application program, the pet display interface being used for displaying a pet commodity owned by a second account, and the second account being an account used for logging in to the terminal;
displaying, when a triggering operation on a first pet commodity in the pet display interface is detected, a pet information interface of a second pet commodity, the pet information interface of the second pet commodity comprising a sale control of the second pet commodity, and the second pet commodity being a second virtual pet or a virtual prop used for obtaining the second virtual pet; and
transmitting a release request to a server when a triggering operation on the sale control is detected, the release request being used for triggering the server to obtain third verification information; and releasing the second pet commodity in a trading interface of the application program when the third verification information indicates that the release request is valid, the third verification information being release verification information stored in a blockchain system and used for indicating validity of the release request.

16. A method according to claim 13, further comprising:
displaying the pet display interface of the application program, the pet display interface being used for displaying a pet commodity owned by a third account, and the third account being an account logging in to the terminal;
displaying, when a triggering operation on a second pet commodity in the pet display interface is detected, a pet information interface of the second pet commodity, the second pet commodity being a virtual pet having been released, the pet information interface comprising a suspension control of the second pet commodity, and the second pet commodity being a second virtual pet or a virtual prop used for obtaining the second virtual pet; and
transmitting a suspension request to a server when a triggering operation on the suspension control is detected, the suspension request being used for triggering the server to obtain fifth verification information; and suspending the second pet commodity from the trading interface when the fifth verification information indicates that the suspension request is valid, the fifth verification information being suspension verification information stored in a blockchain system and used for indicating validity of the suspension request.

17. An apparatus for trading a virtual pet commodity, providing backend support for an application program, the application program being provided with virtual pets, and at least one pet image of each of the virtual pets being generated based on a genetic inheritance rule, the apparatus further comprising a memory for storing computer instructions and a processor in communication with the memory, wherein, when the processor executes the instructions, the processor is configured to cause the apparatus to:
display a trading interface of the application program, the trading interface comprising a purchase control of a first pet commodity, and the first pet commodity being a first virtual pet or a virtual prop used for obtaining the first virtual pet;
transmit a purchase request to a server when a triggering operation on the purchase control is detected, the purchase request being used for triggering the server to obtain first verification information, and transfer ownership of the first pet commodity from a second account to a first account when the first verification information indicates that the purchase request is valid, the first verification information being first type information stored in a blockchain system and used for indicating validity of the purchase request, the first account being an account used for logging in to the apparatus to initiate the purchase request, and the second account being an account selling the first pet commodity; and
display the first pet commodity in a pet display interface of the application program, the pet display interface being used for displaying a virtual pet owned by the first account.

18. The apparatus according to claim 17, wherein, when the processor executes the instructions, the processor is configured to further cause the apparatus to:
display a price trend control of the first pet commodity in the trading interface; and
display a price trend interface of the first pet commodity when a triggering operation on the price trend control is detected, wherein the price trend interface comprises a price of the first pet commodity at each time point after the first pet commodity is released.

19. The apparatus according to claim 17, wherein, when the processor executes the instructions, the processor is configured to further cause the apparatus to:
display the pet display interface of the application program, the pet display interface being used for displaying a pet commodity owned by a second account, and the second account being an account logging in to the apparatus;
display, when a triggering operation on a first pet commodity in the pet display interface is detected, a pet information interface of a second pet commodity, the pet information interface of the second pet commodity comprising a sale control of the second pet commodity, and the second pet commodity being a second virtual pet or a virtual prop used for obtaining the second virtual pet; and
transmit a release request to a server when a triggering operation on the sale control is detected, the release request being used for triggering the server to obtain third verification information; and release the second pet commodity in a trading interface of the application program when the third verification information indicates that the release request is valid, the third verification information being release verification information stored in a blockchain system used for indicating validity of the release request.

20. The apparatus according to claim 17, wherein, when the processor executes the instructions, the processor is configured to further cause the apparatus to:
display the pet display interface of the application program, the pet display interface being used for displaying a pet commodity owned by a third account, and the third account being an account logging in to the apparatus;
display, when a triggering operation on a second pet commodity in the pet display interface is detected, a pet information interface of the second pet commodity, the second pet commodity being a virtual pet having been released, the pet information interface comprising a suspension control of the second pet commodity, and the second pet commodity being a second virtual pet or a virtual prop used for obtaining the second virtual pet; and
transmit a suspension request to a server when a triggering operation on the suspension control is detected, the suspension request being used for triggering the server to obtain fifth verification information; and suspend the second pet commodity from the trading interface when the fifth verification information indicates that the suspension request is valid, the fifth verification information being suspension verification information stored in a blockchain system and used for indicating validity of the suspension request.
